(19) United States
(12) Patent Application Publication
(10) Pub. No.: US 2025/0178553 A1
(43) Pub. Date: Jun. 5, 2025

(54) VEHICLE ATTACHMENT UNIT

(71) Applicant: Ralf Pietschmann, Loechgau (DE)

(72) Inventor: Ralf Pietschmann, Loechgau (DE)

(73) Assignee: ACPS Automotive GmbH, Ingersheim (DE)

(21) Appl. No.: 19/045,739

(22) Filed: Feb. 5, 2025

Related U.S. Application Data
(63) Continuation of application No. PCT/EP2023/071205, filed on Jul. 31, 2023.

(30) Foreign Application Priority Data
Aug. 8, 2022 (DE) 102022119904.5

(51) Int. Cl. B60R 19/48; B60D 1/24; B60D 1/48; B60D 1/54; B60R 19/34

(52) U.S. Cl. CPC B60R 19/48; B60D 1/243; B60D 1/485; B60R 19/34; B60D 1/54

(57) ABSTRACT

In order to form a vehicle attachment unit that is mountable or mounted on a vehicle rear such that it is also usable on the vehicle rear in the absence of a trailer element, it is proposed that the vehicle attachment unit should comprise a crumple unit, which is mountable on the vehicle rear below a bumper unit and has an impact body that extends transversely to a longitudinal center plane which, in the condition mounted on the vehicle rear, coincides with a vehicle longitudinal center plane, and mounting bodies arranged to either side of the longitudinal center plane, supporting the impact body in relation to the vehicle rear and maintaining a spacing therefrom, and that the crumple unit should be configured for the motor vehicle and meet crash requirements thereof on the motor vehicle with no trailer element provided.

### CROSS-REFERENCE TO RELATED PATENT APPLICATION

This application is a continuation of international application number PCT/EP2023/071205 filed on 31 Jul. 2023 and claims the benefit of German application number 10 2022 119 904.5 filed on 8 Aug. 2022.

The present disclosure relates to the subject matter disclosed in international application number PCT/EP2023/071205 of 31 Jul. 2023 and German application number 10 2022 119 904.5 of 8 Aug. 2022, which are incorporated herein by reference in their entirety and for all purposes.

### BACKGROUND OF THE INVENTION

The invention relates to a vehicle attachment unit which is mountable or mounted on a vehicle rear and on which a trailer element, in particular a ball neck, is mountable when necessary.

Vehicle attachment units of this kind are known from the prior art, wherein the vehicle attachment units are configured exclusively for receiving or mounting a trailer element.

In accordance with an embodiment of the invention, a vehicle attachment unit of this kind is formed such that it is also beneficially usable on the vehicle rear in the absence of a trailer element.

### SUMMARY OF THE INVENTION

In accordance with an embodiment of the invention, provision is made in the case of a vehicle attachment unit of the type mentioned in the introduction that the vehicle attachment unit comprises a crumple unit, which is mountable on the vehicle rear below a bumper unit and has an impact body that extends transversely to a longitudinal center plane which, in the condition mounted on the vehicle rear, coincides with a vehicle longitudinal center plane, and mounting bodies arranged to either side of the longitudinal center plane, supporting the impact body in relation to the vehicle rear and maintaining a spacing therefrom, and that the crumple unit is configured for the motor vehicle and meets crash requirements on the motor vehicle with no trailer element provided.

In particular here, the crumple unit is configured such that it meets the energy absorption properties demanded of the safety requirements for the respective motor vehicle.

The advantage of the solution according to the invention can be seen in the fact that on the one hand it provides the possibility of meeting the crash requirements on a motor vehicle, and on the other hand a trailer element can be mounted without exchanging this crumple unit.

Thus, a vehicle attachment unit of this kind may for example be installed as a crumple unit as standard in a motor vehicle type, and the question of whether the vehicle is provided with a trailer element or not then merely needs the trailer element to be mounted on this vehicle attachment unit.

Here, it is particularly advantageous if the crumple unit of the vehicle attachment unit is adapted for introducing into the vehicle rear the forces that occur when a trailer element is mounted.

This means that the crumple unit not only serves to meet the crash requirements for the respective vehicle with no trailer element, but is also configured such that it is able to introduce into the vehicle rear the forces that occur when a trailer element is mounted, and thus in particular in this case to meet the requirements made of a trailer coupling with a vehicle attachment unit of this kind that has a trailer element.

Here, it is particularly advantageous if the impact body of the crumple unit is connectable to the trailer element, and in that when the trailer element is connected to the crumple unit the crumple unit transmits to the vehicle rear all the forces which act on the trailer element during use of the trailer coupling.

More detailed statements have not been made in this context as regards the form taken by the impact body.

Thus, one advantageous embodiment provides for the impact body to take the form of a hollow body.

In this case, fundamentally the impact body could take the form of a hollow body.

However, it is particularly advantageous, in particular in order to achieve the necessary resistance to torsion and impact, if the impact body has a cross section differing from a round or oval cross section.

For example, in this case the impact body could have a triangular or polygonal cross section.

One advantageous embodiment provides for the impact body to have a wall element facing the vehicle and a wall element facing away from the vehicle, and in that an upper wall element facing away from a road and a lower wall element facing a road extend between these, and in that the wall elements are fixedly connected to one another.

Here, preferably at least some of the wall elements are connected to one another by a weld connection, wherein the weld connection contributes not only to connecting the wall elements but also to the resistance to torsion and bending of the impact body.

Here, where appropriate wall elements may also merge with one another at a bend.

However, it is also conceivable for all the wall elements to be connected to one another by a weld connection.

A further advantageous embodiment provides for the impact body to be provided with stiffening in a central region.

In particular here, the impact body is provided at least in the region of the wall element facing the vehicle or the wall element facing away from the vehicle or both wall elements with stiffening in a central region, since when a trailer element is mounted the central region is subject to the greatest forces for transmission from the impact body to the vehicle rear.

In order to save on weight in the region of the impact body, it is preferably provided for the impact body to be provided with cutouts to the side of the central region in order to reduce its weight.

Cutouts of this kind in the impact body may be provided in one or more of the wall elements, preferably in each of the wall elements.

In order to prevent the resistance to torsion and bending of the impact body from being significantly impaired by the cutouts, it is preferably provided for the cutouts to have an extent in a transverse direction of the impact body that is at most 1.5 times their extent transversely to the transverse direction, in particular the extent in a substantially vertical height direction, or a substantially horizontal direction.

Here, a substantially vertical height direction is a direction forming an angle of at most ±20° with the vertical, and a substantially horizontal direction forms an angle of ±20° with the horizontal.

Moreover, when cutouts are provided it is favorably provided for wall regions of the impact body that have an extent in the transverse direction of at least 0.5 times the extent of the cutouts to be located between the cutouts in the transverse direction.

Wall regions or transverse webs that have sufficient width in this way allow the resistance to torsion and bending of the impact body to be ensured.

In particular, for this purpose it is necessary for all the wall elements in which there are the above-mentioned cutouts also to have the above-mentioned wall regions between the cutouts.

It is particularly advantageous here if the wall regions located between the cutouts in the transverse direction run, at least in certain regions, transversely to the transverse direction, and thus in particular in the region of the wall elements contribute to the tensile and shear strength of the respective wall element.

Further, it is preferably provided for the cutouts to have an external contour of substantially round and/or oval basic shape.

A basic shape of this kind for the cutout makes it possible to prevent tensions building up in edge regions of the cutouts.

As an alternative to this, however, it is also provided for the cutouts to have an external contour having the basic shape of a triangle, in particular with rounded corner regions, wherein such cutouts taking the shape of a triangle have the advantage that the wall regions located between them may be arranged such that they extend in particular obliquely to the transverse direction, that is to say both in the transverse direction and also in the height direction or width direction, and thus likewise improve the tensile and shear strength of the individual wall elements.

Here, in particular the rounded corner regions also serve to prevent peaks in tension in the corner regions.

In the context of the exemplary embodiments that have been described so far, the cutouts serve in particular to save on weight, something which is relevant when the walls of the hollow body forming the impact body are of relatively thick sheet-metal material, such as a thickness of 4 mm or more with a tensile strength of 400 MPa or less. In this case, the cutouts allow weight to be saved on with insubstantial impairment to the resistance to torsion and bending.

Another advantageous solution provides for the cutouts, in relation to the wall regions surrounding them, to have edge regions that are raised up relative to the wall regions.

Raising up edge regions of cutouts in this way makes it possible to significantly improve the resistance to torsion and bending of the impact body and thus also of the individual wall elements, such that it is possible where appropriate to reduce the material thickness of the wall elements, for example to less than 5 mm, or better 4 mm or less.

In this case, for example the tensile strength of the sheet-metal material may be between 400 MPa and 800 MPa.

Here, it is in particular provided for the edge regions to entirely surround the cutouts and thus to have the stabilizing effect of a closed annular body surrounding the cutouts.

It is particularly advantageous if the raised-up edge regions have a height transversely to the wall regions surrounding them that corresponds to at least twice a thickness of the surrounding wall regions, with the result that the in particular entirely surrounding wall regions bring about enhanced resistance to torsion and twisting of the respective wall element.

In order to enhance the stability of the wall elements, it is preferably provided for at least some of the wall elements to have enhanced resistance to deformations as a result of shaping, in particular being shaped out of a flat material.

In the simplest case, shaping of this kind may consist in providing the respective wall element with curves or bends, which may extend in the most diverse directions.

It is particularly advantageous if at least one of the wall elements has a curve that runs transversely to the transverse direction.

A curve of this kind may for example be a curve or a bend having a bend line transverse to the transverse direction or in the transverse direction.

For example, one advantageous solution provides for at least two wall elements to be formed in one piece as a result of shaping.

For example, in this case the bend line of the shaping may extend in the transverse direction.

However, it is also conceivable additionally to stabilize the bend line of the shaping in certain regions by a shaping that runs transversely thereto.

Here, one advantageous exemplary embodiment provides for at least one of the wall elements and the wall element adjoining this to be parts of a profiled body, for example an angled or U-shaped profile.

One particularly advantageous solution provides for at least one of the wall elements to have a stamped bead.

A stamped bead of this kind may result in stability in the most diverse directions, depending on the orientation.

For example, one advantageous solution provides for at least one of the wall elements, or the elements facing the vehicle and facing away from the vehicle, to have a stamped bead that extends in the transverse direction, in order to enable tensile and compressive forces in the direction of the vehicle rear or away from the vehicle rear to be transmitted to the mounting bodies in optimum manner.

Another advantageous solution provides, in addition or as an alternative, for at least one of the wall elements to have stamped beads which are arranged successively in the transverse direction of the impact body and which in particular improve the resistance to torsion and deflection of the impact body.

Beads of this kind preferably run obliquely to the transverse direction.

Here, all the beads may run obliquely to the transverse direction in the same direction.

As an alternative to this, one advantageous solution provides for successive beads in the transverse direction to run transversely to one another and thus in particular for the beads to be arranged in the manner of a zigzag in the transverse direction.

A course of this kind for the beads allows the resistance to deflection of the wall elements to be improved.

The provision of beads allows in particular high-strength sheet-metal material having for example a tensile strength of 800 MPa or more and a thickness of 3 mm or less to be used, and hence the weight of the vehicle attachment unit to be reduced.

More detailed statements have not yet been made as regards connecting the wall elements themselves.

Thus, one advantageous solution provides, in the region of a connection between two of the wall elements, for at least one of the wall elements to project beyond the other wall element by a web region.

A solution of this kind has the advantage that the web region contributes to further advantageous stiffening of the respective wall element that forms the web region, since the extent thereof in the direction in which the web region projects beyond the other wall element prolongs the extent of the wall element.

It is even more advantageous if the web region also has a bend, and thus, in particular if the bend runs transversely to the extent of the web region, it provides an additional stiffening transverse to the extent of the web region.

More detailed statements have not yet been made as regards connecting two mutually abutting wall elements.

Fundamentally, the wall elements may be connected using a conventional weld seam.

In order to have as little effect as possible on the material properties, it is preferably provided for a laser weld seam to be provided for the purpose of connecting two mutually abutting wall elements.

In this case, the laser weld seam may be a continuous or an interrupted weld seam.

Further, a further advantageous solution provides, where two mutually adjoining wall elements are connected, for them to form a push-in connection.

A push-in connection of this kind means that regions of the wall elements engage in one another.

In particular, for the purpose of forming the push-in connection it is provided for one of the wall elements to have a recess in which the other wall element engages by a projection adapted thereto.

Moreover, it is preferably provided for the wall elements to be welded to one another at least in the region of the push-in connection, such that this produces a long-lasting, stable and in particular unbreakable connection between the wall elements even when there is a varying action of force on the impact body.

Likewise, more detailed statements have not been made as regards the course taken by the wall elements forming the impact body.

Thus, one advantageous solution provides for the course taken by at least one of the wall elements to differ from a course in one plane, such that the impact body has a variable cross section.

In particular here, it is provided for the wall element facing away from the vehicle to be curved in the direction away from the wall element facing the vehicle, such that the impact body has a variable cross section at least as regards the spacing between the wall element facing the vehicle and the wall element facing away from the vehicle.

More detailed statements have not been made, in conjunction with the above explanation of the individual embodiments of the solution according to the invention, as regards mounting the trailer element.

Thus, one advantageous solution provides for a mounting base for mounting the trailer element to be mountable on the impact body of the crumple unit.

A mounting base of this kind may be a mounting base for a fixedly mounted trailer element or a removable trailer element, or indeed a mounting base for a pivotal trailer element.

Here, the term “trailer element” is to be understood to mean that it is either configured for connection to a trailer or indeed as a so-called receiver, that is to say a receptacle for a coupling element, or indeed takes a form such that a load carrier, in particular a bicycle carrier, is connectable to it.

For example, it would be conceivable here for the mounting base to be mounted on the outside of the impact body.

It is particularly favorable if the mounting base is mountable such that it is integrated into the impact body, such that the spatial volume of the impact body can be selected to be as large as possible and can then be utilized to mount the mounting base in the impact body.

In particular here, it is provided for the mounting base to be connected, preferably detachably connected, to the wall element facing the vehicle and the wall element facing away from the vehicle and in particular also to the upper wall element.

Further, it is preferably provided for the lower wall element facing a road to have a cutout for installation of the mounting base, such that the mounting base may subsequently easily be mounted such that it is integrated into the impact body.

Preferably here, the cutout is dimensioned such that it is possible to mount the mounting base with the trailer element previously mounted thereon, such that the entire unit comprising the mounting base and the trailer element may be mounted in the impact body in one step.

It is particularly advantageous here if there is held on the mounting base a bearing unit, in particular a pivotal bearing unit, for the trailer element, by which the trailer element is pivotal from a working position into a rest position.

In particular, in this case too the cutout is also dimensioned such that the mounting base, together with the bearing unit, in particular the pivotal bearing unit for the trailer element, is mountable through the cutout, such that the bearing unit can previously be mounted on the mounting base and the bearing unit connected to the mounting base and the trailer element connected to the bearing unit may subsequently be mounted in the impact body.

In this way, in particular the entire mounting base, together with the bearing unit, is later located in the impact body and is surrounded thereby.

A further advantageous solution provides, in the rest position, for the trailer element to be at least partly, in particular also entirely, received in the impact body.

In this way, the impact body can take as voluminous a form as possible for the purpose of improving its stability and can thus in particular serve to receive therein not only the mounting base with the bearing unit but also the part of the trailer element that is connected to the bearing unit, in the working position, and also at least partly, in particular entirely, the trailer element in the rest position.

This solution has the great advantage that the entire space between the vehicle rear and the bumper unit is available for the impact body to be arranged and to take its shape, since the fact of mounting the mounting element together with the bearing unit and the trailer element later, in the working position and also in the rest position, does not take up any additional space between the vehicle rear and the bumper unit, but only makes use of the space available for this purpose within the impact body.

It is particularly advantageous here if the lower wall element is provided, in the central region receiving the mounting base, with a cutout of which the extent is such that the mounting unit, together with the pivotal bearing unit mounted thereon, is insertable between the wall element facing the vehicle and the wall element facing away from the vehicle, and is mountable such that it is integrated into the impact body, with the result that in particular the entire mounting base, together with the bearing unit, is located within the impact body.

It is particularly favorable if the mounting base runs obliquely to both the wall element facing away from the vehicle and also the wall element facing the vehicle and abuts against them by way of mounting flanges.

In particular here, it is provided for the mounting unit to have another mounting flange that is configured to abut against the upper wall element and to be connected thereto.

In particular, it is favorably provided for the mounting base, with the bearing unit mounted thereon and together with the trailer element held by the bearing unit, to be insertable as a whole into the impact body by way of a cutout in the lower wall element.

Furthermore, it is favorable here if the mounting base is connectable to the wall element facing the vehicle by way of a mounting flange and to the wall element facing away from the vehicle by way of a mounting flange and to the upper wall element by way of a mounting flange.

It is particularly favorable if the mounting base is detachably connectable to the wall elements by way of the mounting flanges.

In particular here, the mounting base may favorably be connected to the wall elements by way of the mounting flanges using screws, with the result that the mounting base may be inserted into the impact body and/or where appropriate also removed therefrom in a simple manner with the vehicle attachment unit already mounted.

Likewise, more detailed statements have not yet been made as regards the form taken by the mounting base.

Thus, a favorable solution provides for the mounting base to be formed from molded parts made of flat material that are connected to one another and are for example mutually overlapping or arranged at a spacing from one another.

An alternative solution provides for the mounting base to be configured as a solid component that is connectable by way of edge regions respectively to the wall element facing the vehicle, the wall element facing away from the vehicle and the upper wall element.

Likewise, more detailed statements have not yet been made as regards connecting the deformation bodies to the vehicle rear.

Thus, one advantageous solution provides for the respective deformation body to be supported on a foot that abuts or is configured to abut against the vehicle rear.

Preferably, for this purpose each of the feet is provided with a central region that takes a planar form and enables planar support against the vehicle rear.

In order to connect the feet to the vehicle rear, it is preferably provided for the feet to be fixable to the vehicle rear by way of anchoring elements.

In particular in this case, the feet are provided with anchoring elements acting on a stabilized region of the vehicle rear.

More detailed statements have not yet been made as regards the form taken by the deformation bodies themselves.

Fundamentally, the deformation bodies could take any form enabling sufficient energy absorption in the event of a crash.

It is particularly favorable if the deformation bodies have connection elements arranged between the respective foot and a holding region of the impact body.

Preferably, for this purpose the connection elements comprise fingers that are fixedly connected to the holding region of the impact body.

Preferably, for this purpose it is provided for the fingers to abut against the lower and upper wall elements of the impact body and to be connected to holding regions thereof.

Moreover, for the purpose of additionally supporting the impact body, it is provided for the connection elements to have a supporting web that extends between the fingers and stabilizes at least the fingers relative to one another.

In particular, provided in the respective connection element between the supporting web and the respective foot is a central opening, which favors deformability of the supporting web in the direction of the respective footing body.

It is particularly favorable if the wall element of the impact body that faces the vehicle abuts against the supporting web and is in particular fixedly connected thereto, with the result that this provides a further support for the impact body against the connection elements.

In order, in addition to the above connections between the impact body and the connection elements, to provide a yet further support, it is preferably provided for the wall element facing away from the vehicle to abut on the fingers, in particular on the end regions of the fingers, and thus also itself to be supported directly on the fingers.

In order in the event of a crash to enable the connection element to deform, in particular in the region of the fingers, it is preferably provided for the holding regions, which are connected to the fingers, of the upper and lower wall elements to be decoupled from the wall element facing the vehicle by cutouts such that the holding regions of the upper and lower wall elements may, together with the fingers, be deformed independently of the wall element facing the vehicle, in order in the event of a crash to absorb as much crash energy as possible.

In particular, it is provided for the connection elements to take a form such that in the event of a crash they deform as a whole in the direction of the crash, that is to say that the connection elements do not only deform as individual parts but all the connection elements undergo deformation in the direction of the crash in order to take up as much crash energy as possible.

For example, during this, in their regions adjoining the supporting web the fingers move toward or away from one another, and the supporting web moves in the direction of the footing body, in particular reducing the extent of the central opening.

In case the crash energy to be taken up by the connection elements in the event of a crash is not sufficient, it is preferably provided for additional energy absorption elements, which in the event of a crash deform in the direction of the crash, to be associated with the connection elements of the deformation bodies.

However, additional energy absorption elements of this kind may for example not only serve to absorb energy in the event of a crash but may also for example additionally be configured to transmit to the feet forces that are transmitted from the trailer element to the impact body.

A particularly advantageous embodiment of the additional energy absorption elements that deform in the event of a crash provides for them to be bodies that fold up in the direction of the crash, that is to say that they fold up such that the spacing between the feet and the impact body is reduced, and thus in addition energy is absorbed by the additional energy absorption elements.

For example, the additional energy absorption elements are constructed such that they have a central body and, extending from this, support elements that run on one side to the foot and on the other to the impact body and in the event of a crash deform, for example fold up.

Another advantageous solution provides for the additional energy absorption elements to take the form of hollow bodies.

In this case, the hollow bodies are preferably formed such that they extend around a geometric axis, and such that the geometric axis runs in the direction of a crash or transversely to the direction of a crash.

Thus, the above description of solutions according to the invention comprises in particular the different combinations of features that are defined by the sequentially numbered embodiments below:

1. A vehicle attachment unit (20) which is mountable or mounted on a vehicle rear (14) and on which a trailer element (40), in particular a ball neck (42), is mountable when necessary, wherein the vehicle attachment unit (20) comprises a crumple unit (60), which is mountable on the vehicle rear (14) below a bumper unit (16) and has an impact body (62) that extends transversely to a longitudinal center plane (18) which, in the condition mounted on the vehicle rear (14), coincides with a vehicle longitudinal center plane (18), and mounting bodies (64, 65) arranged to either side of the longitudinal center plane (18), supporting the impact body (62) in relation to the vehicle rear (14) and maintaining a spacing therefrom, and wherein the crumple unit (60) is configured for the motor vehicle (10) and meets crash requirements thereof on the motor vehicle (10) with no trailer element (40) provided.

2. The vehicle attachment unit according to embodiment 1, wherein the crumple unit (60) of the vehicle attachment unit (20) is adapted for introducing into the vehicle rear (14) the forces that occur when a trailer element (40) is mounted.

3. The vehicle attachment unit according to embodiment 1 or 2, wherein the impact body (62) of the crumple unit (60) is connectable to the trailer element (40), and wherein when the trailer element (40) is connected to the crumple unit (60) the crumple unit (60) transmits to the vehicle rear (14) all the forces which act on the trailer element (40) during use of the trailer coupling (30).

4. The vehicle attachment unit according to one of the preceding embodiments, wherein the impact body (62) takes the form of a hollow body.

5. The vehicle attachment unit according to embodiment 4, wherein the impact body (62) has a cross section with at least three corners.

6. The vehicle attachment unit according to one of the preceding embodiments, wherein the impact body (62) has a wall element (82) facing the vehicle and a wall element (88) facing away from the vehicle, and wherein an upper wall element (84) facing away from a road and a lower wall element (86) facing a road extend between these, and wherein the wall elements (82, 84, 86, 88) are fixedly connected to one another.

7. The vehicle attachment unit according to embodiment 6, wherein at least some of the wall elements (82, 84, 86, 88) are connected to one another by a weld connection.

8. The vehicle attachment unit according to one of the preceding embodiments, wherein the impact body (62) is provided with stiffening (112, 82si, 88si) in a central region (61).

9. The vehicle attachment unit according to one of the preceding embodiments, wherein the impact body (62) is provided with cutouts (114s, 116s) to the side of the central region (61).

10. The vehicle attachment unit according to one of the preceding embodiments, wherein the cutouts (114s, 116s) have an extent in a transverse direction (QR) of the impact body (62) that is at most 1.5 times their extent transversely to the transverse direction (QR).

11. The vehicle attachment unit according to embodiment 10, wherein wall regions (114S, 116S) of the impact body (62) that have an extent in the transverse direction (QR) of at least 0.5 times the extent of the cutouts (114s, 116s) are located between the cutouts (114s, 116s) in the transverse direction (QR).

12. The vehicle attachment unit according to one of embodiments 9 to 11, wherein the wall regions (114S, 116S) located between the cutouts (114s, 116s) in the transverse direction (QR) run, at least in certain regions, transversely to the transverse direction (QR).

13. The vehicle attachment unit according to one of embodiments 9 to 12, wherein the cutouts (114s, 116s) have an external contour of substantially round and/or oval basic shape.

14. The vehicle attachment unit according to one of embodiments 9 to 12, wherein the cutouts (114s, 116s) have an external contour having the basic shape of a triangle, in particular with rounded corner regions.

15. The vehicle attachment unit according to one of embodiments 9 to 14, wherein the cutouts (114s, 116s), in relation to the wall regions (204) surrounding them, have edge regions (202) that are raised up relative to the wall regions (204).

16. The vehicle attachment unit according to embodiment 15, wherein the raised-up edge regions (202) have a height transversely to the wall regions (204) surrounding them that corresponds to at least twice a thickness of the surrounding wall regions (204).

17. The vehicle attachment unit according to one of embodiments 4 to 16, wherein at least some of the wall elements (82, 84, 86, 88) have enhanced resistance to deformations as a result of shaping.

18. The vehicle attachment unit according to embodiment 17, wherein at least two wall elements (82, 84, 86, 88) are formed in one piece as a result of shaping.

19. The vehicle attachment unit according to one of the preceding embodiments, wherein at least one of the wall elements (82) and the wall elements (84, 86) extending away from this are parts of an angled or profiled body, for example a U-shaped profile.

20. The vehicle attachment unit according to one of embodiments 17 to 19, wherein at least one of the wall elements (82, 88) has a stamped bead (82si, 88si).

21. The vehicle attachment unit according to one of embodiments 17 to 19, wherein at least one of the wall elements (82, 84, 86, 88) has stamped beads (86qi, 88qi) which are arranged successively in the transverse direction (QR) of the impact body (62).

22. The vehicle attachment unit according to embodiment 21, wherein the successively arranged beads (86qi, 88qi) run obliquely to the transverse direction (QR).

23. The vehicle attachment unit according to embodiment 22, wherein successive beads (86qi, 88qi) in the transverse direction (QR) each run transversely to one another.

24. The vehicle attachment unit according to one of embodiments 4 to 23, wherein, in the region of a connection between two of the wall elements (82, 84, 86, 88), at least one of the wall elements (82, 84, 86, 88) projects beyond the other wall element (82, 84, 86, 88) by a web region (82SB, 88SB).

25. The vehicle attachment unit according to embodiment 24, wherein the web region (82SB) also has a bend (82U).

26. The vehicle attachment unit according to one of embodiments 4 to 25, wherein a laser weld seam is provided for the purpose of connecting two mutually abutting wall elements (82, 84, 86, 88).

27. The vehicle attachment unit according to one of embodiments 4 to 26, wherein, where two mutually adjoining wall elements (82, 84, 86, 88) are connected, they form a push-in connection (82a, 88a, 84v, 86v).

28. The vehicle attachment unit according to embodiment 27, wherein, for the purpose of forming the push-in connection, one of the wall elements (82, 84, 86, 88) has a recess (82a, 88a) in which the other wall element (84, 86) engages by a projection (84v, 86v) adapted thereto.

29. The vehicle attachment unit according to embodiment 27 or 28, wherein the wall elements (82, 84, 86, 88) are welded to one another at least in the region of the push-in connection.

30. The vehicle attachment unit according to one of embodiments 4 to 29, wherein the course taken by at least one of the wall elements (82, 84, 86, 88) differs from a course in one plane.

31. The vehicle attachment unit according to one of embodiments 4 to 30, wherein the wall element (88) facing away from the vehicle is curved in the direction away from the wall element (82) facing the vehicle.

32. The vehicle attachment unit according to one of the preceding embodiments, wherein a mounting base (70) for mounting the trailer element (40) is mountable on the impact body (62) of the crumple unit (60).

33. The vehicle attachment unit according to one of the preceding embodiments, wherein the mounting base (70) is mountable such that it is integrated into the impact body (62).

34. The vehicle attachment unit according to one of the preceding embodiments, wherein the mounting base (70) is connected, preferably detachably connectable, to the wall element (82) facing the vehicle and the wall element (88) facing away from the vehicle and in particular also to the upper wall element (86).

35. The vehicle attachment unit according to one of the preceding embodiments, wherein the lower wall element (86) facing a road has a cutout (92) for installation of the mounting base (70).

36. The vehicle attachment unit according to embodiment 35, wherein the cutout (92) is dimensioned such that it is possible to mount the mounting base (70) with the trailer element (40) previously mounted thereon.

37. The vehicle attachment unit according to one of the preceding embodiments, wherein there is held on the mounting base (70) a bearing unit (72), in particular a pivotal bearing unit, for the trailer element (40), by which the trailer element (40) is pivotal from a working position (A) into a rest position (R).

38. The vehicle attachment unit according to embodiment 37, wherein, in the rest position (R), the trailer element (40) is at least partly, in particular entirely, received in the impact body (62).

39. The vehicle attachment unit according to one of the preceding embodiments, wherein the lower wall element (86) is provided, in the central region (61) receiving the mounting base (70), with a cutout (92) of which the extent is such that the mounting unit (70), together with the bearing unit (72) mounted thereon, is insertable between the wall element (82) facing the vehicle and the wall element (88) facing away from the vehicle, and is mountable such that it is integrated into the impact body (62), with the result that in particular the entire mounting base (70), together with the bearing unit (72), is located within the impact body (62).

40. The vehicle attachment unit according to embodiment 39, wherein the mounting base (70) runs obliquely to both the wall element (88) facing away from the vehicle and also the wall element (82) facing the vehicle and abuts against them by way of mounting flanges (94, 96).

41. The vehicle attachment unit according to embodiment 40, wherein the mounting unit (70) has another mounting flange (98) that is configured to abut against the upper wall element (84) and to be connected thereto.

42. The vehicle attachment unit according to one of the preceding embodiments, wherein the mounting base (70), with the bearing unit (72) mounted thereon and together with the trailer element (40) held by the bearing unit (72), is insertable as a whole into the impact body (62) by way of a cutout (92) in the lower wall element (84).

43. The vehicle attachment unit according to embodiment 42, wherein the mounting base (70) is connectable to the wall element (82) facing the vehicle by way of a mounting flange (94) and to the wall element (88) facing away from the vehicle by way of a mounting flange (96) and to the upper wall element (84) by way of a mounting flange (98).

44. The vehicle attachment unit according to one of the preceding embodiments, wherein the mounting base (70) is detachably connectable to the wall elements (82, 84, 88) by way of the mounting flanges (94, 96, 98).

45. The vehicle attachment unit according to one of the preceding embodiments, wherein the mounting base (70) is connectable to the wall elements (82, 84, 88) by way of the mounting flanges (94, 96, 98) using screws.

46. The vehicle attachment unit according to one of the preceding embodiments, wherein the mounting base (70) is formed from molded parts (102, 103) made of flat material that are connected to one another and are for example mutually overlapping or arranged at a spacing from one another.

47. The vehicle attachment unit according to one of the preceding embodiments, wherein the mounting base (70′) is configured as a solid component that is connectable by way of edge regions (104, 106, 108) respectively to the wall element (82) facing the vehicle, the wall element (88) facing away from the vehicle and the upper wall element (84).

48. The vehicle attachment unit according to one of the preceding embodiments, wherein the respective mounting body takes the form of a deformation body (64) and is supported on a foot (66) that abuts or is configured to abut against the vehicle rear (14).

49. The vehicle attachment unit according to embodiment 48, wherein each of the feet (66) has a central region (124) that takes a planar form.

50. The vehicle attachment unit according to embodiment 48 or 49, wherein the feet (66) are fixable to the vehicle rear (14) by way of anchoring elements.

51. The vehicle attachment unit according to embodiment 50, wherein the feet (66) are provided with anchoring elements engaging with a stabilized region of the vehicle rear (14).

52. The vehicle attachment unit according to one of the preceding embodiments, wherein the deformation bodies (64) have connection elements (122) arranged between the respective foot (66) and a holding region (152) of the impact body (62).

53. The vehicle attachment unit according to embodiment 52, wherein the connection elements (122) have fingers (126, 128) that are fixedly connected to the holding region (152) of the impact body (62).

54. The vehicle attachment unit according to embodiment 53, wherein the fingers (126, 128) abut against the lower and upper wall elements (84, 86) of the impact body (62) and are connected to holding regions (152) thereof.

55. The vehicle attachment unit according to embodiment 53 or 54, wherein the connection elements (122) have a supporting web (142) that extends between the fingers (126, 128), and wherein provided in particular in the respective connection element (122) between the supporting web (142) and the foot (66) is a central opening (143).

56. The vehicle attachment unit according to embodiment 55, wherein the wall element (82) of the impact body (62) that faces the vehicle abuts against the supporting web (142) and is in particular fixedly connected thereto.

57. The vehicle attachment unit according to one of embodiments 53 to 56, wherein the wall element (88) facing away from the vehicle abuts on the fingers (126, 128).

58. The vehicle attachment unit according to one of embodiments 53 to 57, wherein the holding regions (152), which are connected to the fingers (126, 128), of the upper and lower wall elements (84, 86) are decoupled from the wall element (82) facing the vehicle by cutouts (154).

59. The vehicle attachment unit according to one of embodiments 57 to 58, wherein the connection elements (122) take a form such that in the event of a crash they deform as a whole in the direction of the crash (156).

60. The vehicle attachment unit according to one of embodiments 52 to 59, wherein additional energy absorption elements (162), which in the event of a crash deform in the direction of the crash (156), are associated with the connection elements (122) of the deformation bodies (64).

61. The vehicle attachment unit according to embodiment 60, wherein the additional energy absorption elements (162) are configured to take up forces that are transmitted from the trailer element (40) to the impact body (62).

62. The vehicle attachment unit according to embodiment 60 or 61, wherein the additional energy absorption elements (162) take the form of bodies that fold up in the direction of a crash (156).

63. The vehicle attachment unit according to one of embodiments 60 to 62, wherein the additional energy absorption elements (162, 162″″) have a central body (164, 195) and, extending from this, support elements (166, 168, 196, 198) that run on one side to the foot (66) and on the other to the impact body (62) and in the event of a crash are foldable in the direction of the crash (156).

64. The vehicle attachment unit according to one of embodiments 60 to 63, wherein the additional energy absorption elements (162′, 162″) take the form of hollow bodies (172, 174, 182, 184).

65. The vehicle attachment unit according to embodiment 64, wherein the hollow bodies (172, 174, 182, 184) extend around a geometric axis (176, 186), and wherein the geometric axis (176, 186) runs in the direction of a crash (156) or transversely to the direction of a crash (156).

Further features and advantages of the invention form the subject matter of the description below and the representation in the drawing of some exemplary embodiments.

### BRIEF DESCRIPTION OF THE DRAWINGS

FIG. 1 shows a side view of a motor vehicle with, mounted thereon, a first exemplary embodiment according to the invention of a vehicle attachment unit, provided with a trailer element;

FIG. 2 shows a rear view of the motor vehicle according to FIG. 1, provided with the first exemplary embodiment of a vehicle attachment unit according to the invention, provided with a trailer element;

FIG. 3 is a perspective illustration of the first exemplary embodiment of a vehicle attachment unit, provided with a trailer element according to a first exemplary embodiment of a trailer element according to the invention;

FIG. 4 shows a plan view of the vehicle attachment unit according to FIG. 3, as seen from a road;

FIG. 5 shows a rear view of the vehicle attachment unit according to FIG. 3;

FIG. 6 shows a plan view, seen in the direction of the road, of the vehicle attachment unit according to FIG. 3;

FIG. 7 is a perspective illustration of a first version of a mounting base, with a trailer element mounted using a pivotal bearing unit;

FIG. 8 is an illustration of a detail of the first version of the mounting base for the vehicle attachment unit;

FIG. 9 is an illustration of a second version of the mounting base for the vehicle attachment unit;

FIG. 10 is an illustration, similar to FIG. 4, of a second exemplary embodiment of a vehicle attachment unit according to the invention, provided with a second exemplary embodiment of a trailer element according to the invention;

FIG. 11 is an illustration of a third exemplary embodiment of a vehicle attachment unit according to the invention;

FIG. 12 is a section along the line 12-12 in FIG. 11;

FIG. 13 is a side view of the vehicle attachment unit according to the first exemplary embodiment, with a configuration of a first exemplary embodiment of the deformation body, in each case in the form of a connection element;

FIG. 14 is an enlarged perspective illustration of the deformation body according to FIG. 13, facing the viewer;

FIG. 15 is a section along the line 15-15 in FIG. 14, before a crash;

FIG. 16 is a section along the line 15-15 in FIG. 14, after a crash;

FIG. 17 is an illustration of a fourth exemplary embodiment of a vehicle attachment unit according to the invention, with a second exemplary embodiment of the deformation body, comprising a connection element and an additional energy absorption element;

FIG. 18 is an enlarged perspective illustration, with a view of the deformation body according to FIG. 17 from above left;

FIG. 19 is an illustration of just the additional energy absorption element of the deformation body of the second exemplary embodiment, according to FIG. 18;

FIG. 20 is an illustration of just the additional energy absorption element of the deformation body of the fourth exemplary embodiment of the vehicle attachment unit, with a view in the direction of the arrow X in FIG. 19;

FIG. 21 shows a first variant of an additional energy absorption element, illustrated as part of the deformation element in conjunction with the connection element;

FIG. 22 is an illustration of just the first variant of the additional energy absorption element according to FIG. 21;

FIG. 23 is a second variant of the additional energy absorption element, illustrated as part of the deformation element in conjunction with the respective connection element;

FIG. 24 is an illustration of just the second variant of the additional energy absorption element according to FIG. 23;

FIG. 25 is an illustration of a third variant of the additional energy absorption element, as part of the deformation element in conjunction with the connection element;

FIG. 26 is an illustration of just the third variant of the additional energy absorption element according to FIG. 25;

FIG. 27 is a perspective illustration of a fifth exemplary embodiment of a vehicle attachment unit according to the invention;

FIG. 28 is a detail illustration of a section along the line 28-28 in FIG. 27;

FIG. 29 is a detail perspective illustration of a sixth exemplary embodiment of a vehicle attachment unit according to the invention, as seen in the direction of travel;

FIG. 30 is a detail perspective illustration of the sixth exemplary embodiment, as seen in the opposite direction to the direction of travel;

FIG. 31 is a section along the line 31-31 in FIG. 29;

FIG. 32 is a perspective illustration of a seventh exemplary embodiment of a vehicle attachment unit according to the invention; and

FIG. 33 is a perspective illustration of an eighth exemplary embodiment of a vehicle attachment unit according to the invention.

### DETAILED DESCRIPTION OF THE INVENTION

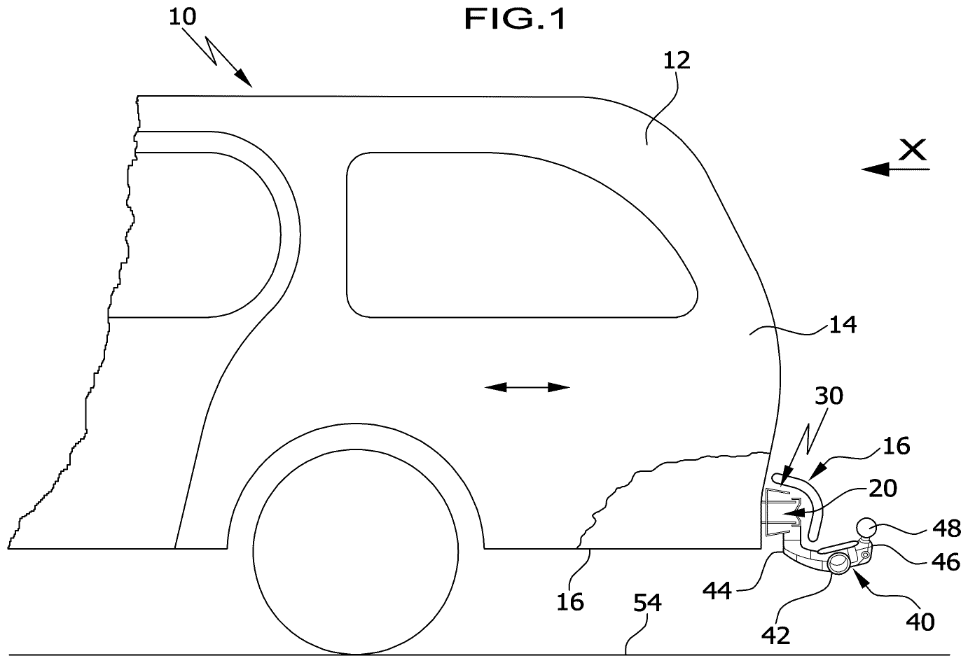

The invention is applicable to a motor vehicle 10 which has a vehicle body 12 that carries at a vehicle rear 14 a bumper unit designated 16 as a whole (FIG. 1).

A vehicle attachment unit according to the invention, designated 20 as a whole, is arranged at the vehicle rear 14 and hidden by the bumper unit 16, and may be part of a trailer coupling which is designated 30 as a whole if, in addition to the vehicle attachment unit 20, a trailer element 40 taking the form in particular of a ball neck 42 is provided, wherein the trailer element 40 extends from a first end 44 connected to the vehicle attachment unit 20 to a second end 46 carrying a coupling element 48 taking the form for example of a coupling ball.

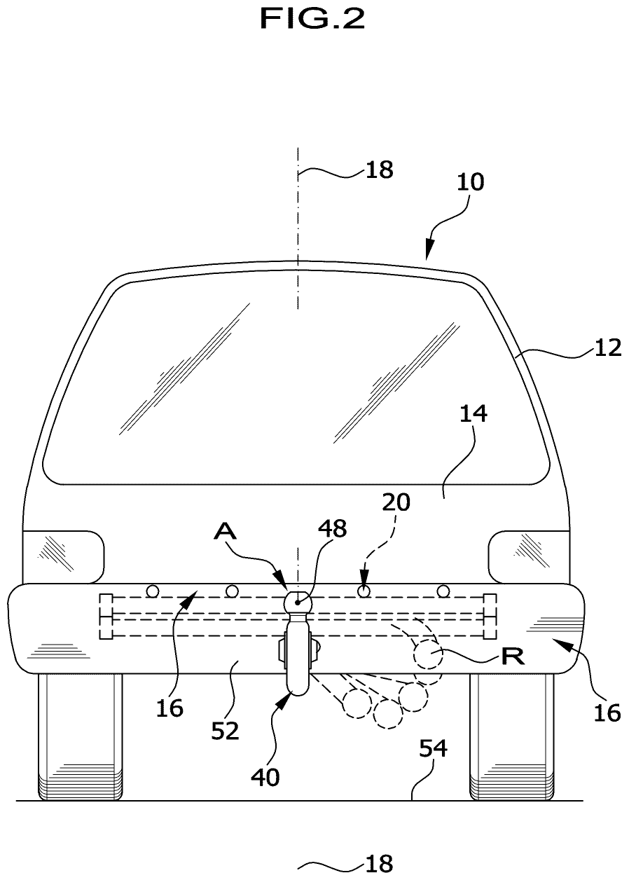

As illustrated in FIG. 2, it is provided for example in the case of an exemplary embodiment for the trailer element 40 to be movable from a working position A, in which the coupling element 48 is arranged substantially symmetrically in relation to a longitudinal center plane 18 of the trailer coupling 30 that coincides with the vehicle longitudinal center plane, through below a lower edge 52 of the bumper unit 16 that faces a road and into a rest position R, in which the trailer element 40 is in a rest position R with the coupling element 48 hidden by the bumper unit 16.

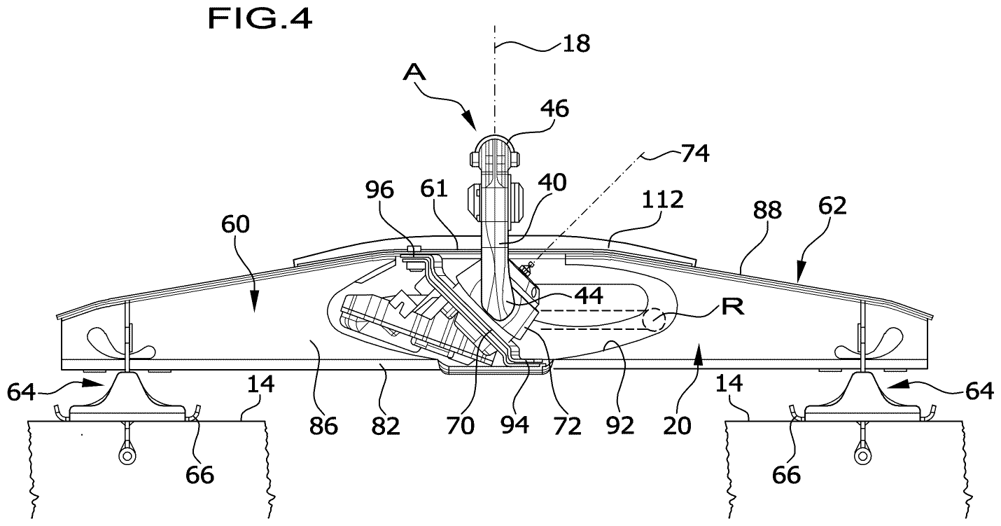

This is performed for example by a pivotal movement about a pivot axis that is not discernible in FIGS. 1 and 2 but is discernible for example in FIG. 4.

Further, as illustrated in FIG. 2, it is provided for the vehicle attachment unit 20 to extend to either side of the longitudinal center plane 18, hidden by the bumper unit 16.

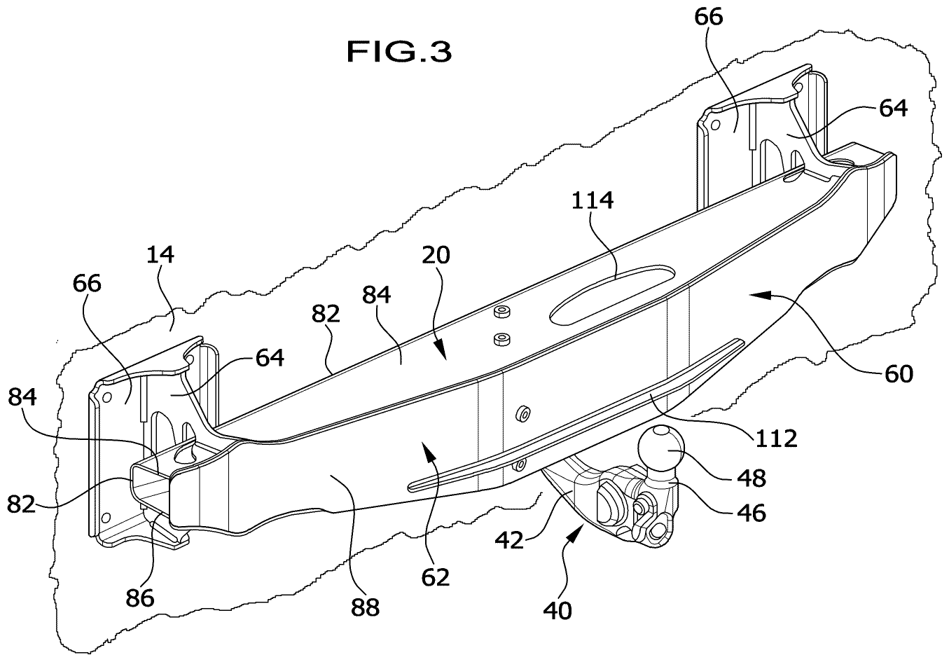

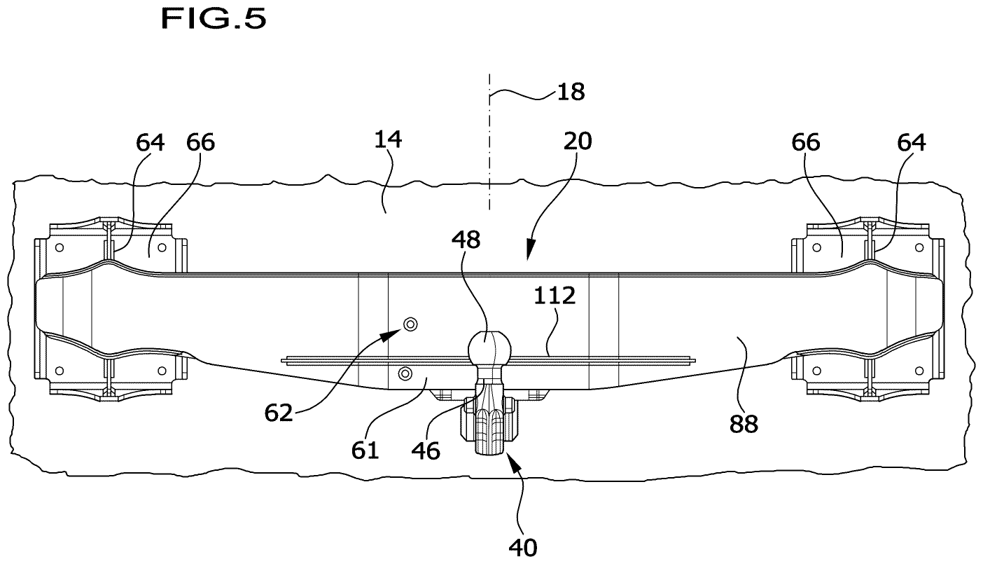

As illustrated in FIGS. 3 to 5, the vehicle attachment unit 20 takes the form of a crumple unit 60 that has an impact body 62 which extends transversely to the longitudinal center plane 18 and is supported at the vehicle rear 14 by mounting bodies arranged between the impact body 62 and the vehicle rear 14 and taking the form of deformation bodies 64, which for their part abut or are configured to abut against the vehicle rear 14, and are connected or configured to be connected to the vehicle rear 14, by way of feet 66.

Here, in the solution according to the invention both the impact body 62 and also the deformation bodies 64 and feet 66 are respectively configured such that they not only transmit the forces provided for the motor vehicle 10 to the vehicle rear 14 in the event of a crash and absorb at least some of the crash energy in the region of the deformation bodies 64, but are also configured such that they are able to take up the forces that occur during operation of a trailer or a load carrier or bicycle carrier from the trailer element 40 and transmit them to the vehicle rear 14.

For this purpose, in the first exemplary embodiment, which is illustrated in FIGS. 4 to 9, the impact body 62 takes the form of a hollow body in which, in the case of a pivotal trailer element 40, there is arranged in a central region 61 a mounting base designated 70, on which the trailer element 40 is supported by way of a bearing unit, which is designated 72 as a whole and takes the form for example of a pivotal bearing unit by which the trailer element 40 is mounted to be pivotal about for example a pivot axis 74, in order to move the trailer element 40 from the working position A, in which the trailer element 40 is shown in solid lines, into the rest position R, which in FIG. 4 is illustrated in dashed lines.

Here, the bearing unit 72 comprises in particular on the one hand a locking unit, in order to fix the trailer element 40 in the working position A and the rest position R, and on the other for example also an in particular electric pivot drive by which the pivotal movement of the trailer element 40 from the working position A into the rest position R and vice versa is performable.

As illustrated in FIGS. 3 to 6, the impact body 62 is formed by a wall element 82 facing the vehicle from which there extend, in the direction of a wall element 88 facing away from the vehicle, an upper wall element 84 facing away from a road and a lower wall element 86 facing a road.

For example, the wall element 82 facing the vehicle, the upper wall element 84 and the lower wall element 86 are formed by a U-shaped profile, for example a deep-drawn part or extruded part, of which the middle limb forms the wall element 82 facing the vehicle and the side limbs form the upper wall element 84 and the lower wall element 86, in which case the upper wall element 84 and the lower wall element 86 each extend as far as the wall element 88 facing away from the vehicle and are fixedly connected thereto.

In this case, for example the wall element 88 facing away from the vehicle is made of a flat material that is welded, at least in certain regions, to the upper wall element 84 and the lower wall element 86 over their extent transverse to the longitudinal center plane 18.

Further, for example the wall element 88 facing away from the vehicle takes a form that is curved in the direction away from the wall element 82 facing the vehicle, with the result that there is sufficient space in the region of the mounting base 70 for it to be received between the wall element 82 facing the vehicle and the wall element 88 facing away from the vehicle.

Further, in the central region receiving the mounting base 70, the lower wall element 86 is provided with a cutout 92 of which the extent is such that the mounting base 70, together with the pivotal bearing unit 72 mounted thereon, is insertable between the wall element 82 facing the vehicle and the wall element 88 facing away from the vehicle and is thus mountable integrated into the impact body 62, such that in particular the entire mounting base 70, together with the bearing unit 72, lies within the impact body 62.

For the purpose of suitably orienting the bearing unit 72 and thus the pivot axis 74, the mounting base 70 runs obliquely relative to both the wall element 82 facing the vehicle and the wall element 88 facing away from the vehicle and abuts against them by way of mounting flanges 94 and 96 respectively.

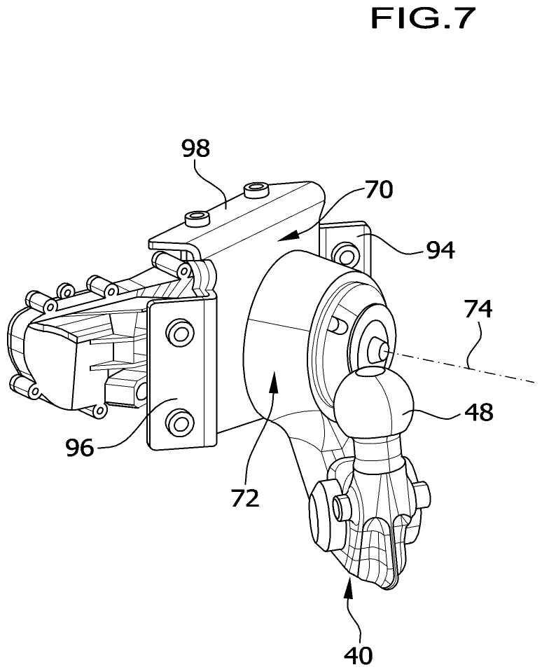

Furthermore, as illustrated in FIG. 7, the mounting unit 70 moreover has a mounting flange 98 that is configured to abut against the upper wall element 84 and to be connected thereto.

Thus, the mounting base 70, with the bearing unit 72 mounted thereon and together with the trailer element 40 held by the bearing unit 72, as illustrated in FIG. 7, is insertable as a whole into the impact body 62 by way of a cutout 92 in the lower wall element 86, and is connectable, in particular detachably connectable, for example by screws, to the wall element 82 facing the vehicle by way of the mounting flange 94 and to the wall element 88 facing away from the vehicle by way of the mounting flange 96 and to the upper wall element 84 by way of the mounting flange 98, such that a simplified way of integrating and mounting the mounting body 70, together with the bearing unit 72 and the trailer element 40, is available.

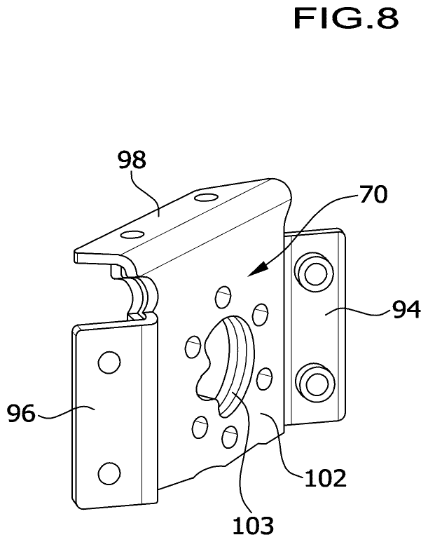

Preferably for this purpose, as illustrated in FIG. 8, the mounting base 70 is formed from molded parts 102 and 103 made of flat material that are connected to one another and are for example mutually overlapping or arranged at a spacing from one another and enable a high degree of flexibility in the shaping of the mounting base 70.

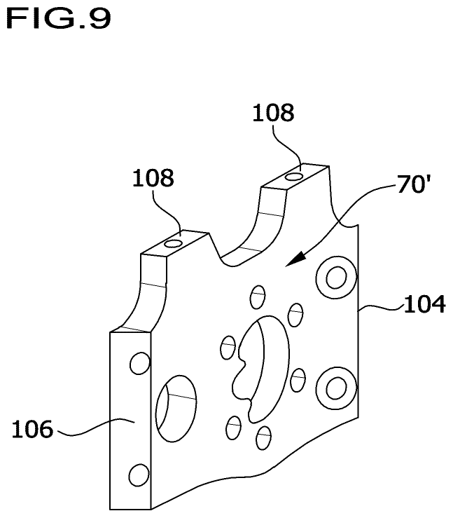

As an alternative to this, however, and as illustrated in FIG. 9, the mounting base 70′ is also configurable as a solid component that is connectable by way of edge regions 104, 106 and 108 respectively to the wall element 82 facing the vehicle, the wall element 88 facing away from the vehicle and the upper wall element 84.

For the purpose of improving the stiffness of the impact body 62 taking the form of a hollow body, in particular in the region of the cutout 92, preferably the wall element 88 facing away from the vehicle is moreover provided with a welded-on stiffening rib 112, which is for example arranged on and connected to the wall element 88 facing away from the vehicle on a side thereof that faces away from the vehicle.

Further, preferably, the upper wall element 84 is provided in the central region 61 with a cutout 114 that improves accessibility to the mounting base 70 and forms for example a free space in which the trailer element 40 can engage, where appropriate also only partially, in the rest position R.

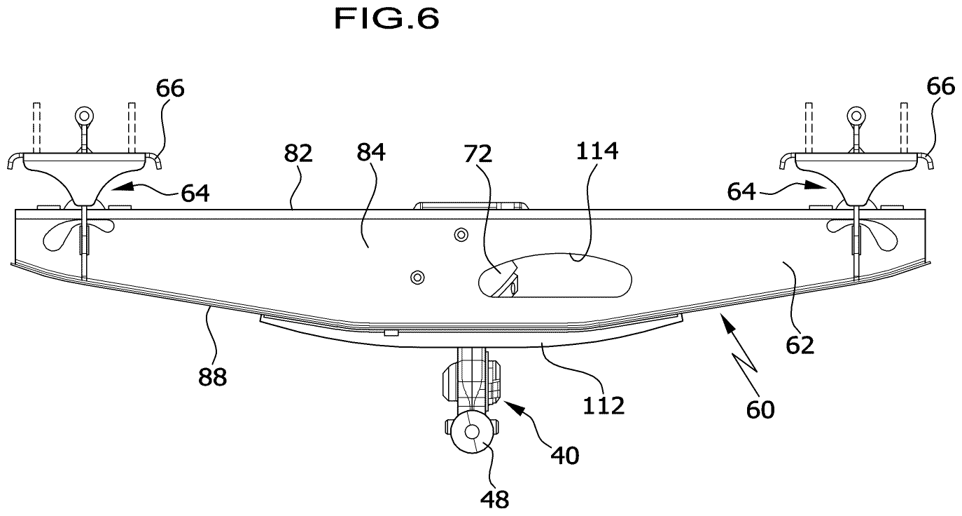

For the purpose of fixing the feet 66 to the vehicle rear 14, they are preferably mountable by way of anchoring elements that engage in the vehicle rear 14.

Where appropriate, additional anchoring elements that are fixable in the vehicle rear are provided, as illustrated in FIG. 6.

In contrast to the first exemplary embodiment, a second exemplary embodiment provides for the trailer element 40, taking the form for example of a ball neck 42, to be provided at the end 44 with a fixing element 45 that is detachably connectable to the vehicle attachment unit 20.

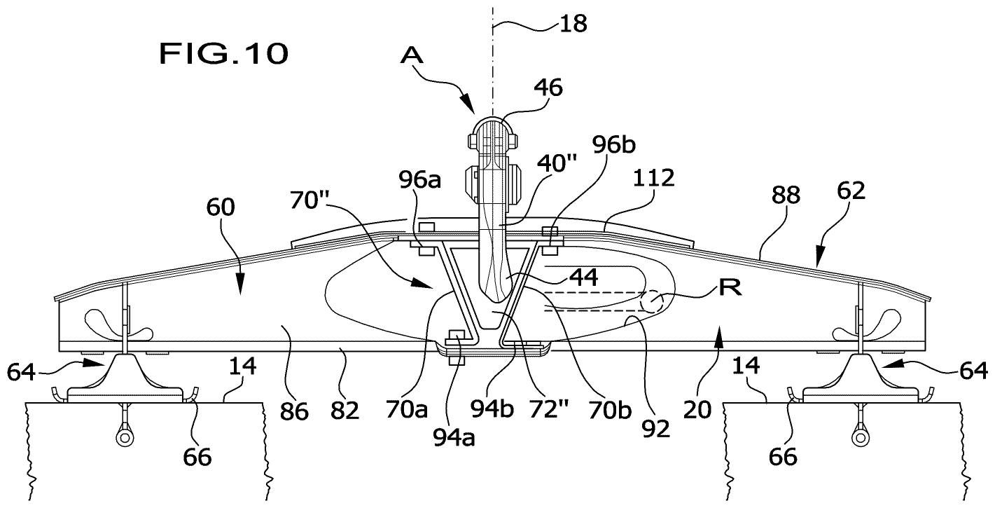

In the second exemplary embodiment, which is illustrated in FIG. 10, the bearing unit 72″ takes the form of a housing 74 with an insertion opening 75 into which the fixing element 45 is configured to be pushed and fixed with positive engagement.

Further, the housing 74 is held on a mounting base 70″ that has two mounting carriers 70a, 70b.

As illustrated in FIG. 10, the fixing element 45 of the trailer element 40″ is arranged in the impact body 62 and has a bearing unit 72″ into which the fixing element 45 can be inserted and, when a fixing position is reached, detachably fixed in the fixing position, received non-displaceably and in a manner preventing rotation.

In the case of the mounting base 70″, this is formed, as illustrated in FIG. 10, from two mounting carriers 70a, 70b which each extend between the wall element 82 facing the vehicle and the wall element 88 facing away from the vehicle, and abut against these by mounting flanges 94a, b and 96a, b respectively.

In particular, the mounting carriers 70a, 70b have another mounting flange 98 that is abuttable against the upper wall element 84 and connectable thereto.

Otherwise, in the second exemplary embodiment that is illustrated in FIG. 10, the impact body 62 takes the same form as that described in conjunction with the first exemplary embodiment above.

In particular in the second exemplary embodiment, the mounting base 70″, with the bearing unit 72″ mounted thereon and together with the trailer element 40″ held by the bearing unit 72″, as illustrated in FIG. 10, is insertable as a whole into the impact body 62 by way of a cutout 92 in the lower wall element 86, and is connectable, in particular detachably connectable, for example by screws, to the wall element 82 facing the vehicle by way of the mounting flanges 94″a, b and to the wall element 88 facing away from the vehicle by way of the mounting flanges 96″a, b and to the upper wall element 84 by way of the mounting flanges 98″a, b, such that a simplified way of integrating and mounting the mounting carriers 70″a, b, together with the bearing unit 72″ and the trailer element 40″, is available.

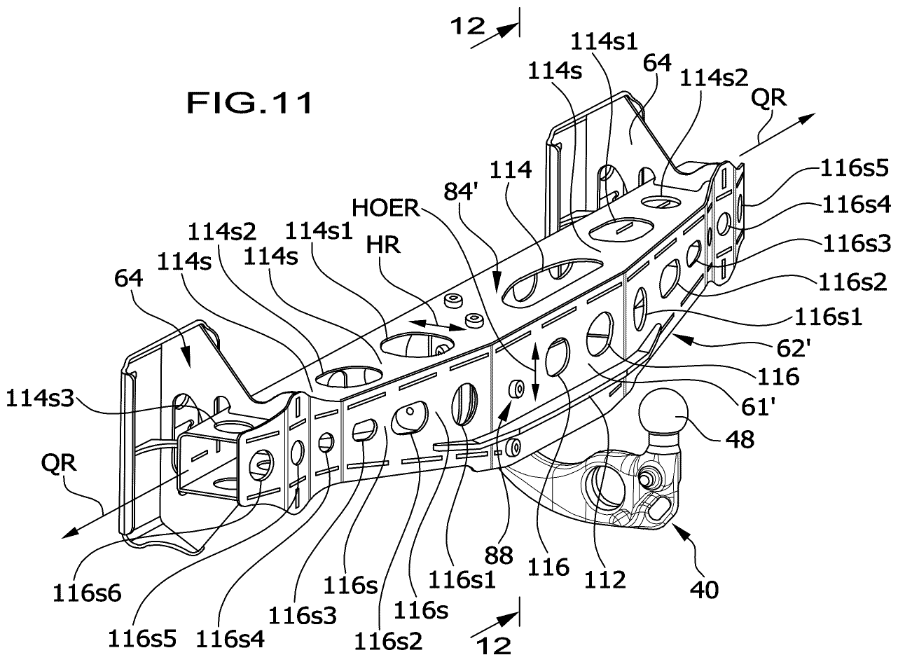

In a third exemplary embodiment of a trailer coupling according to the invention, illustrated in FIG. 11, the impact body 62′ is provided in the central region 61′, in the region of the upper wall element 84′, not only with one or more cutouts 114 but with additional cutouts 114s that are arranged to the side of the central region 61′, for example having cutouts 114s1 and 114s2, which are arranged between the cutout 114 in the central region 61′ and the deformation bodies 64, in order to contribute to an additional saving on weight.

Furthermore, favorably the wall element 88 facing away from the vehicle is also provided both with one or more cutouts 116 in the central region 61′, and also with additional cutouts 116s, for example cutouts 116s1 to 116s6, between the central region 61′ and the lateral outer end of the impact body 62′, and these likewise serve to reduce weight.

Both the cutouts 114s1 to 114s3 and also the cutouts 116s1 to 116s6 are shaped such that, starting from the central region 61′, they do not have a much greater extent in a transverse direction QR pointing in the direction of the deformation bodies 64 than they do in a horizontal direction HR or a height direction HOER extending between the lower wall element 86 and the upper wall element 84.

Preferably, the extent of the cutouts 116s1 to 116s6 and 114s1 to 114s3 is selected such that their extent in the transverse direction QR is at most 1.2 times, or better the same as, their extent in a horizontal direction HR or a height direction HOER running transversely, in particular approximately perpendicular, to the transverse direction.

As a result of this dimensioning of the lateral cutouts 116s1 to 116s6 and 114s1 to 114s3, and because there are still wall regions of significant width in the form of webs 114S and 116S between the cutouts 116s1 to 116s6 and 114s1 to 114s3, of which the extent is at least 0.5 times the extent of the cutouts 116s1 to 116s6 and 114s1 to 114s3 in the transverse direction, it is possible to ensure that the impact body 62 has resistance to torsion.

Preferably, it is also provided for cutouts corresponding to the cutouts 116s1 to 116s6 to be provided in both the lower wall element 86 and also the wall element 82 facing the vehicle.

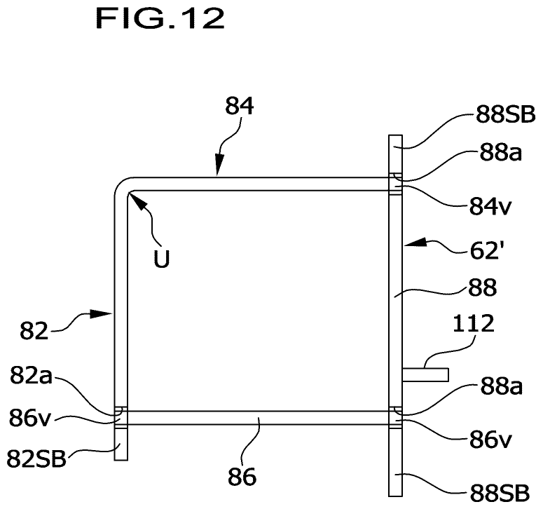

In addition, as illustrated in FIG. 12, only the wall element 82 facing the vehicle and the upper wall element 84 are connected in one piece with one another by a bend U, whereas the upper wall element 84 engages by a projection 84v in a recess 88a that corresponds to the projection 84v, wherein the projection 84v is welded to the recess 88a, for example at least along its longitudinal sides or all the way around, in order to create a stable connection between the upper wall element 84 and the wall element 88 facing away from the vehicle.

Moreover, the lower wall element 86 also engages by projections 86v both in recesses 88a in the wall element 88 facing away from the vehicle and also in recesses 82a in the wall element facing the vehicle, and is welded thereto, for example at least along its longitudinal sides or all the way around, in order to create a stable weld connection between the lower wall element 86 and the wall element 82 facing the vehicle and the wall element 88 facing away from the vehicle.

Further, preferably both the wall element 82 facing the vehicle and also the wall element 88 facing away from the vehicle each project beyond the lower wall element 86 in the direction of the road by a strip region 82SB and 88SB, in order for this additional strip region 82SB and 88SB likewise to create an additional stabilization to prevent deflection either vertically upward or vertically downward.

Similarly, the element 88 facing away from the vehicle also projects beyond the upper wall element 84 by a strip region 88SB in order likewise to improve the stiffness in respect of loads in the vertical direction.

Moreover, also provided in the case of the third exemplary embodiment, illustrated in FIGS. 11 and 12, is the welded-on stiffening rib 112, which contributes to additional stiffening of the wall element 88 facing away from the vehicle in order to compensate for the fact that the wall element 88 facing away from the vehicle has less stiffening in the central region 61′ because of the cutout 92 in the lower wall element 84.

In respect of the other features of the impact body 62′, reference is made to the statements above regarding the features of the impact body 62 in their entirety.

A substantial advantage of the exemplary embodiments that are described above can be seen in the fact that herein the impact body 62, with the deformation bodies 64 and the respective foot 66, can be mounted on the vehicle rear as a vehicle attachment unit 20 that is able to act as a crumple unit without the trailer element 40 with the mounting base 70 being mounted, with the result that, regardless of whether a trailer element 40 is desired or not, in each case and in each vehicle the same vehicle attachment unit 20 can already be mounted at the factory and then serves as a crumple unit in all cases, regardless of whether a trailer unit 40 is mounted or not.

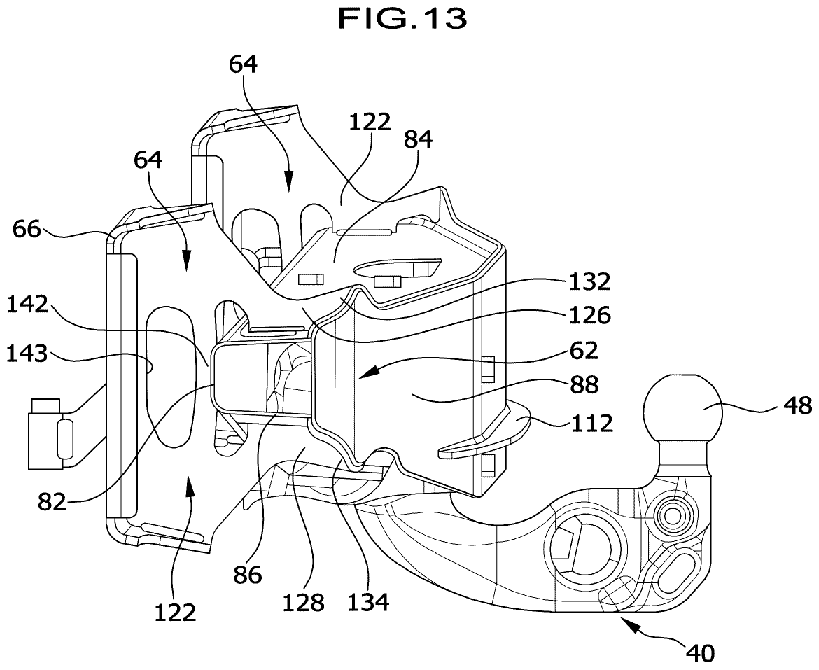

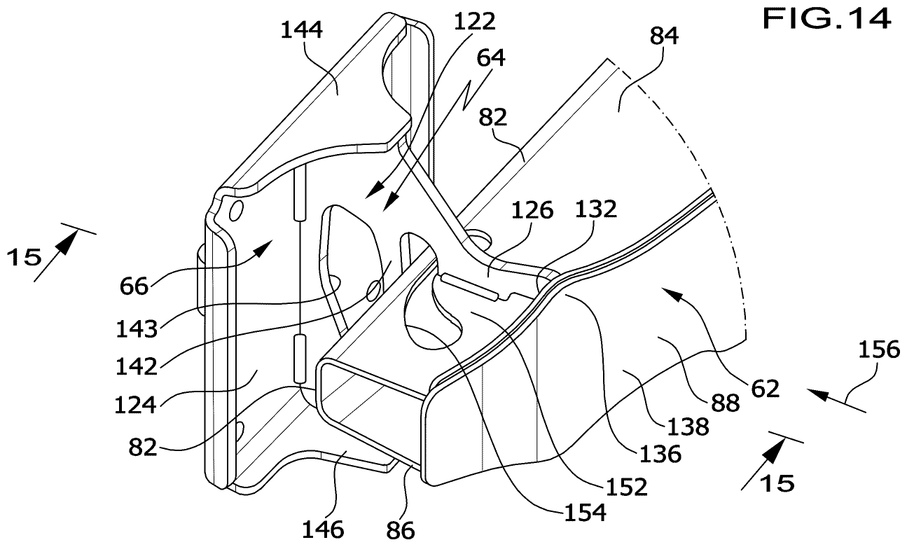

As illustrated in FIGS. 13 and 14 using the example of the first exemplary embodiment of the vehicle attachment unit, in each of the above-described exemplary embodiments each of the deformation elements 64 according to a first exemplary embodiment thereof comprises a deformable connection element 122 which is held on one side against the foot 66 and preferably extends transversely, in particular approximately perpendicular, to a central region 124 of the foot 66 taking a planar form, in the direction of and as far as the impact body 62.

For the purpose of connecting it to the impact body 62, the connection element 122 has two fingers 126, 128, wherein the finger 126 abuts against and is connected to the upper wall element 84 and the finger 128 abuts against and is connected to the lower wall element 86.

Further, the fingers 126 and 128 extend as far as the wall element 88 facing away from the vehicle, and abut against this in each case by an end region 132 and 134 respectively such that the wall element 88 facing away from the vehicle is directly supported by the fingers 126, 128.

For example, for this purpose the wall element 88 facing away from the vehicle has projections 136 and 138 which are thus supported directly on the end regions 132 and 134 of the fingers 126, 128.

Further, the connection element 122 comprises a supporting web 142 that extends between the fingers 126 and 128 and abuts against the wall element 82 of the impact body 62 that faces the vehicle and hence supports it.

Preferably, moreover provided in the connection element 122 between the supporting web 142 and the foot 66 is a central opening 143 which provides the possibility for the supporting web 142 to move such that it deforms in the direction of the foot 66 in the event of a crash.

For the purpose of stabilizing the connection elements 122 relative to the foot 66, the feet 66 moreover have shaped regions 144 and 146 that extend in the same direction as the respective connection element 122 but transversely thereto and receive the connection element 122 between them in its region extending approximately as far as the supporting web 142, and hence stabilize it.

Preferably, in this way each of the connection elements 122 is fixedly connected to the corresponding foot 66 on one side by the planar central region 124 and on the other by the shaped regions 144 and 146.

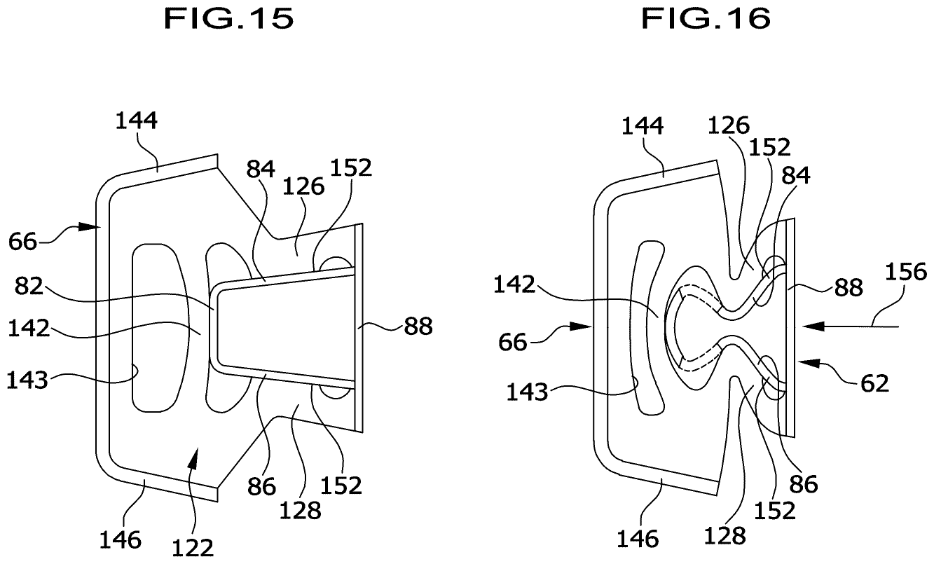

As a result of this connection between the foot 66 and the respective connection element 122, and the connections between this and the impact body 62, the unit comprising the impact body 62 and the deformation bodies 64 is thus able to transmit to the feet 66 forces acting through the trailer element 40 and on the impact body 62 transversely and parallel thereto, wherein these forces are then also introduced in turn through the feet 66 into the vehicle rear 14. (FIG. 15)

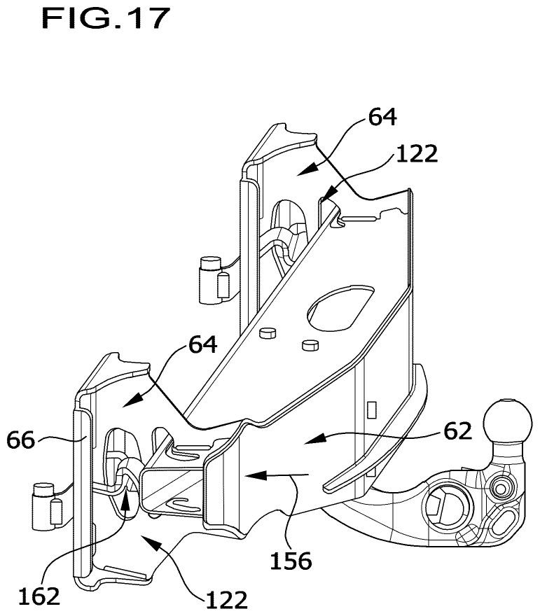

In order, in the event of a crash, to facilitate deformation of the connection body 122, for example the holding regions 152 of the upper wall element 84 and the lower wall element 86, which are connected to the fingers 126 and 128, are freed for movement in relation to the wall element 82 facing the vehicle by a cutout 154, such that in the event of a crash it is possible for the fingers 126 and 128 of the connection element 122 to move toward one another together with the holding regions 152 of the impact body 62, and moreover for the supporting web 142, urged by the wall region 82 of the impact body 62 that faces the vehicle, to move in the direction of the foot 66 so that the central opening 143 is made smaller, with the result that because the fingers 126, 128 move toward one another and the supporting web 142 moves in the direction of the foot 66, and in conjunction with a deformation of the impact body 62 in the holding regions 152, the entire connection element 122 enables movement of the impact body 62 in the direction of a crash 156, that is to say in the direction of the feet 66, and as a result of the ensuing deformations absorbs energy. (FIG. 16)

Depending on the respective specifications for energy that is to be taken up by the deformation bodies 64 in the event of a crash, the connection elements 122 are not always in a position to absorb high levels of energy sufficiently by deformation.

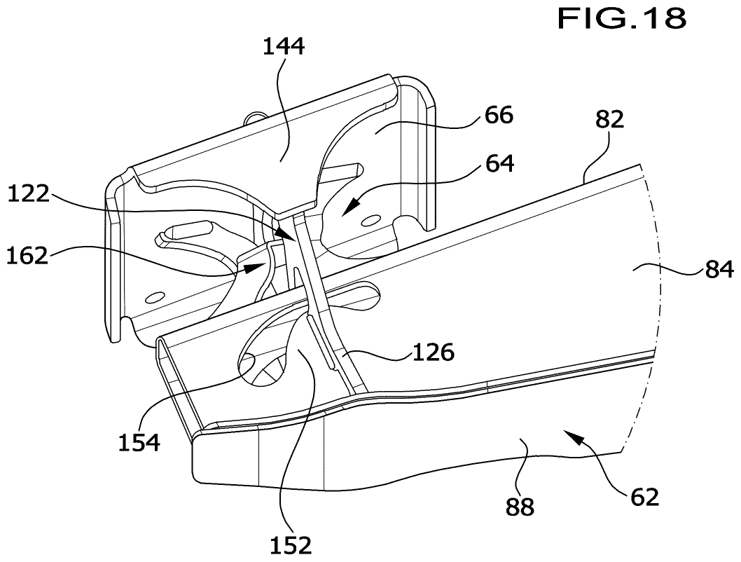

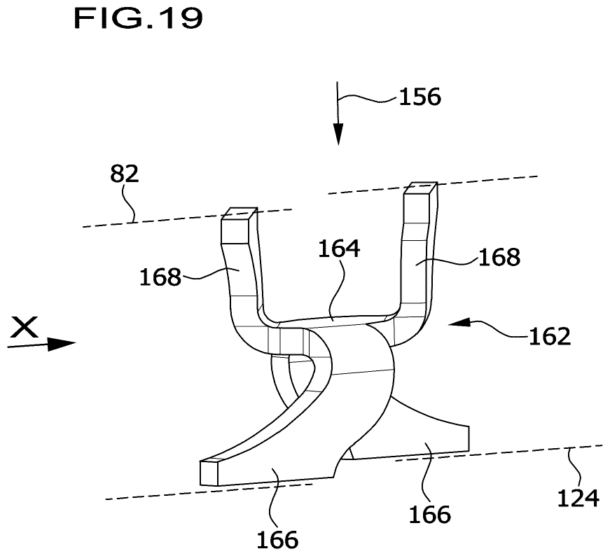

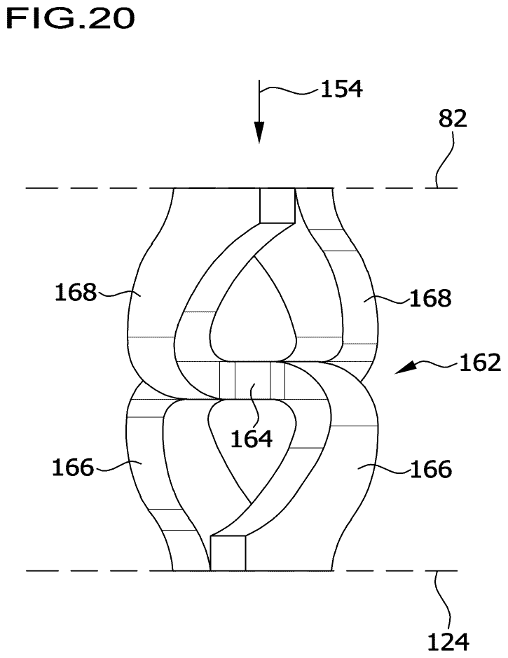

For this reason, in a second exemplary embodiment the connection elements 122, as illustrated in FIGS. 17 to 20, are provided with additional energy absorption elements 162 that are effective in the region of the connection elements 122, between the impact body 62 and the respective foot 66.

An additional energy absorption element 162 of this kind is illustrated in FIGS. 17 to 20 and comprises a central body 164 from which on one side support elements 166 extend to the central region 124 of the respective foot 66 and on the other support elements 168 extend to the wall element 82 facing the vehicle, such that when the wall element 82 of the impact body 62 that faces the vehicle is moved in the direction of the respective foot 66, the support elements 168 and 166 deform and so, as the wall element 82 facing the vehicle moves in the direction of a crash 156, that is to say in the direction of the foot 66, absorb additional energy.

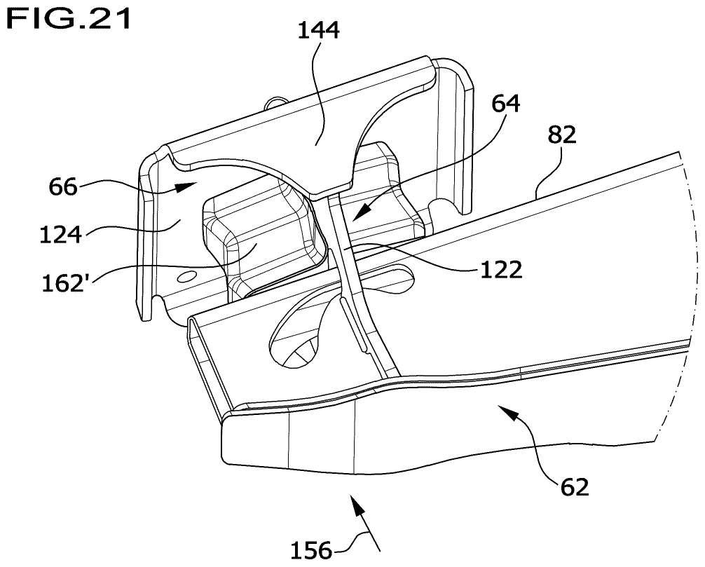

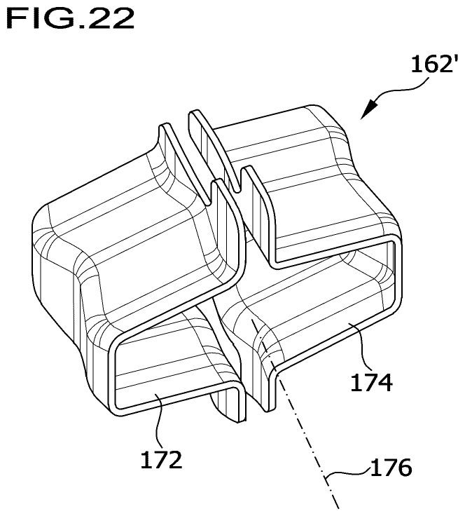

As illustrated in FIGS. 21 and 22, a first variant of an additional energy absorption element 162′ according to the invention is formed by two elements 172 and 174 that take a form similar to the halves of a shell relative to a geometric axis 176, are arranged to either side of the connection element 122, are supported on one side in the central region 124 of the respective foot 66 and on the other against the wall element 82 of the impact body 62 that faces the vehicle, and extend between these with a cross section that varies in planes perpendicular to the geometric axis 176 such that, in the event of the wall element 82 facing the vehicle acting on these elements 172 and 174, because of the variation in cross section they are configured to fold up in the direction of a crash 156, which is approximately parallel to the geometric axis 176, in order to absorb energy.

Preferably, these elements 172 and 174 are fixedly connected to the connection element 122 lying between them, and thus also provide additional stabilization of the connection element 122 between the respective foot 66 and the supporting web 142.

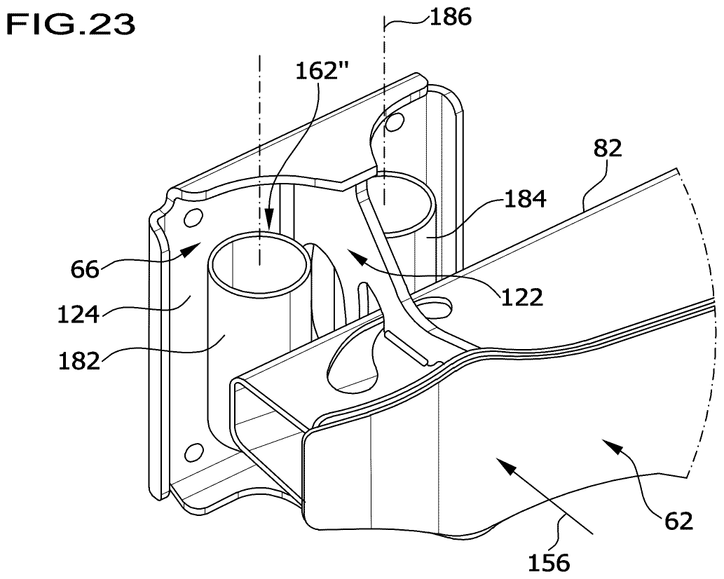

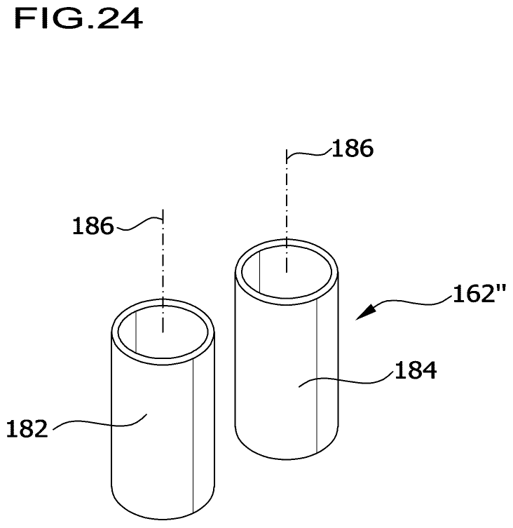

In a second variant of an additional energy absorption element 162″, illustrated in FIGS. 23 and 24, arranged to either side of the connection element 122, in each case running around a geometric axis 186 in the manner of a tube, are bodies 182 and 184 that abut on one side against the central region 124 of the respective foot 66 and on the other support the impact body 62, likewise to either side of the connection element 122, in the region of its wall element 82 facing the vehicle.

Here, the tube-like bodies 182 and 184 extend with their geometric axes 186 parallel to the central region 124 of the respective foot 66 and parallel to the planar extent of the connection element 122, with the result that in the event of a crash the tubular bodies 182 and 184 can deform in the direction of the crash 156, transversely to their geometric axes 186.

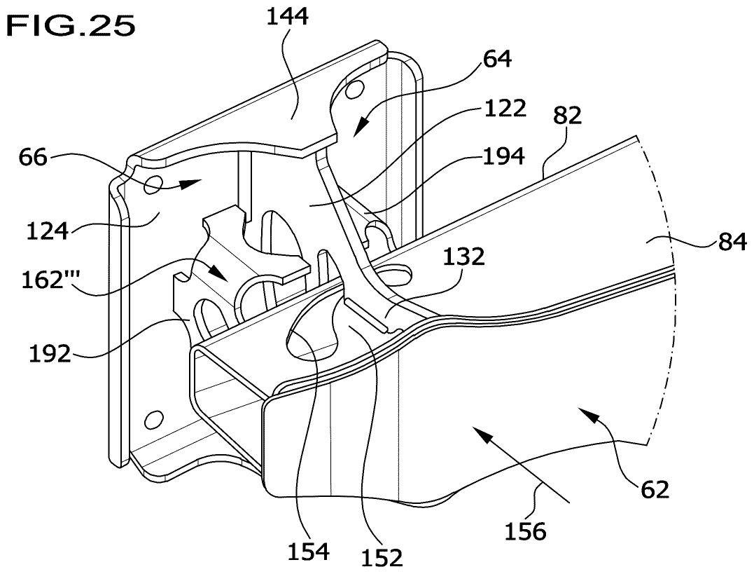

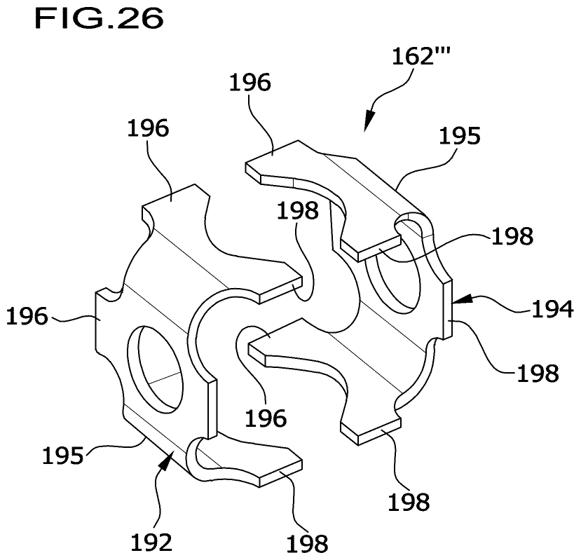

In a third variant of an additional energy absorption element 162″′, illustrated in FIGS. 25 and 26, arranged to either side of the connection element 122 are elements 192, 194 that are in a C shape or a bracket-like shape and are configured such that they are supported by a plurality of foot elements 196 arranged on a central body 195 against the central region 124 of the respective foot 66, on opposite sides of the respective connection element 122, and moreover are supported by one or more foot elements 198 arranged on the central body 195 against the wall element 82 of the impact body 62 that faces the vehicle.

In this case, the energy absorption element 162″′ extends by way of the elements 192 and 194 from the central region 124 of the respective foot 66 as far as the wall element 82 facing the vehicle, and is thus able to take up energy as a result of its shape folding in the direction of a crash 156.

In the exemplary embodiments that have been described hitherto, it is assumed that the vehicle attachment unit 20, in particular the impact body 62, the deformation bodies 64 and the feet 66, are made from steel having a thickness for example of greater than 4 mm, preferably 5 mm or more, in which case the steel has for example a tensile strength of less than 500 MPa.

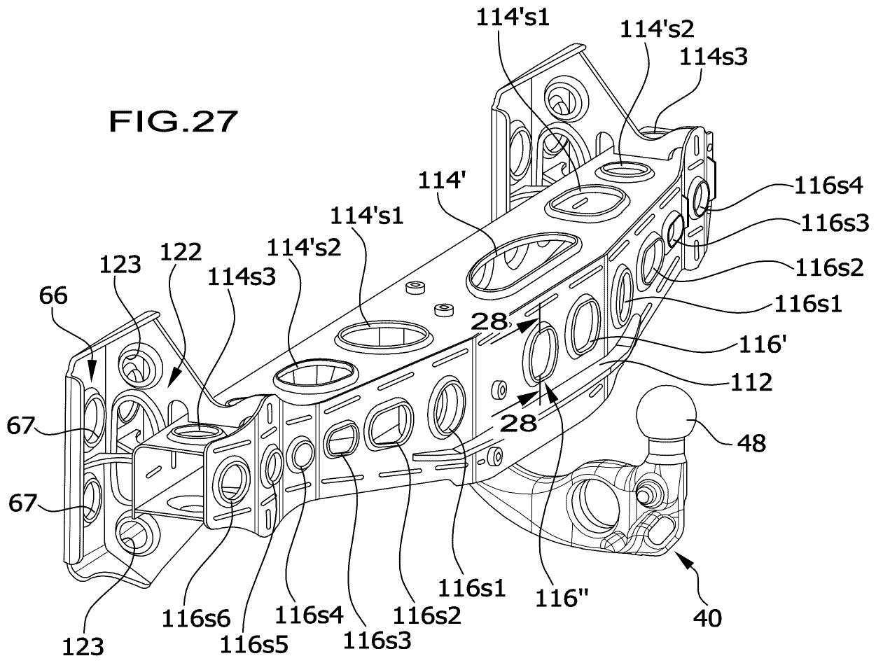

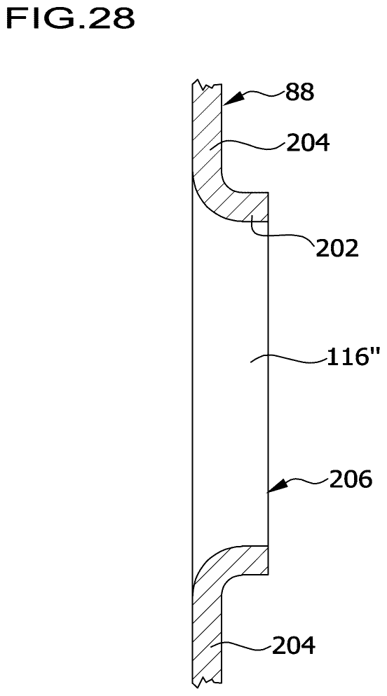

In a fifth exemplary embodiment of a vehicle attachment unit 20, illustrated in FIG. 27 and FIG. 28, cutouts 123 and 67 are provided not only in the region of the impact body 62 but also in the region of the deformation bodies 64, in particular the connection elements 122 and the feet 66, so that these can take a form that saves on weight.

In this solution, however, the cutouts 114, 116 and 123 and 67, as illustrated by way of example with reference to a cutout 116 in FIG. 28, take a form such that they have edge regions 202 that are shaped in relation to the planar regions 204 of the respective component, in this case the wall element 88, such that they extend transversely to the planar region 204 and form an annular body 206 surrounding the respective cutout 116, which has an extent in the height direction running transversely to the planar region 204 that corresponds to at least twice the thickness of the planar region 204, or better at least three times the thickness of the planar region 204, such that the respective annular body 206, because it extends transversely to the planar region 204 of the respective part, in this case the wall element 88, contributes to a significant improvement in the resistance to torsion of the respective part, in this case the wall element 88, which has an effect in all the regions of the impact body 62 and also the deformation body 64 and the foot 66.

For example, this provides the possibility of making these bodies from a material of small material thickness, for example less than 4 mm, preferably approximately 3 mm or less, in which case for example the tensile strength of the material is in the range between 500 and 800 MPa.

Otherwise, the form taken by the impact body 62 of the crumple unit 60 and the deformation bodies 64 and the feet 66 is identical to the form thereof in the exemplary embodiments above, so in addition reference may be made to the content of the statements regarding each of these exemplary embodiments in its entirety.

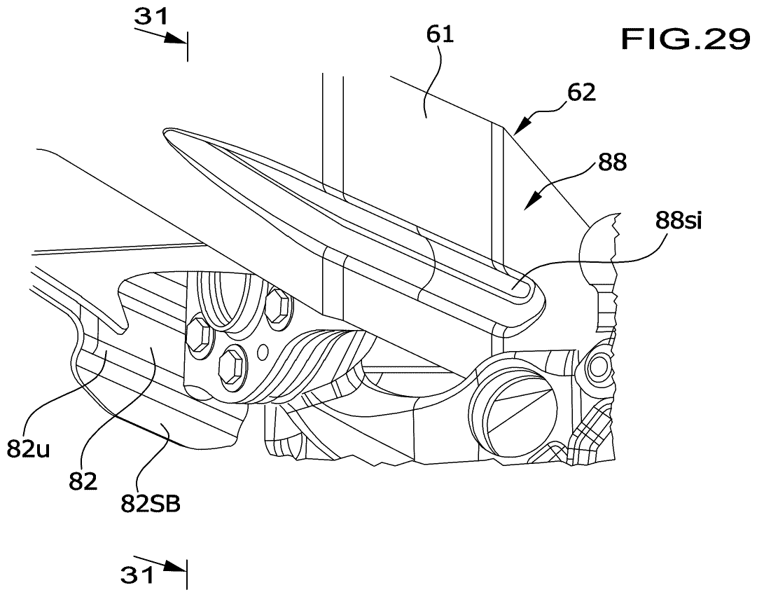

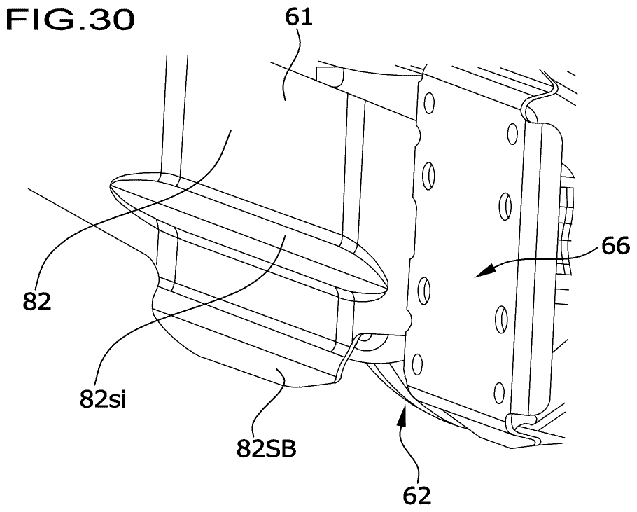

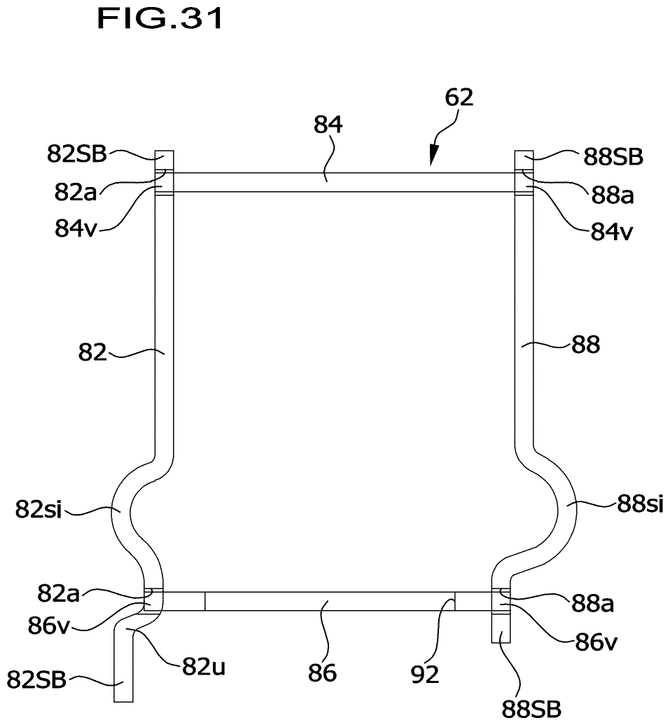

In a sixth exemplary embodiment of a vehicle attachment unit according to the invention, illustrated in FIGS. 29 and 30 and 31, it is provided for the wall element 82 of the impact body 62 that faces the vehicle and the wall element 88 of the impact body 62 that faces away from the vehicle each to be provided with recesses 82a and 88a respectively, in which projections 86v of the lower wall element 86 and projections 84v of the upper wall element engage and are welded to the wall element 82 facing the vehicle and the wall element 88 facing away from the vehicle, such that the connection between the wall elements 82, 84, 86, 88 takes a very stable form.

Moreover, the element 82 facing the vehicle with the strip region 82SB and the wall element 88 facing away from the vehicle with the strip region 88SB extend further down, beyond the lower wall region 86, and with the strip regions 82SB and 88SB extend beyond the upper wall element 84, in order to achieve additional stabilization of the impact body 62.

In order to improve the resistance to twisting, also provided in this impact body 62 are a bead 82si in the wall region 82 facing the vehicle and a bead 88si in the wall region 88 facing away from the vehicle, respectively, and these likewise contribute to stabilization, such that it is possible to select the material from which this impact body 62 is to be made to be of the same quality as in the exemplary embodiment above, wherein in this case the lateral cutouts 114s outside the central region 61, and the cutouts 116 and also lateral cutouts 116s, may be omitted where applicable from the wall element 82 facing the vehicle and the lower wall element 86—with the exception of the cutout 92.

As illustrated in FIGS. 29 and 30, the beads 82si and 88si extend only within the central region 61.

However, it is equally possible for the beads 82si and 88si to go beyond the central region 61, as far as the deformation bodies 64.

Moreover, in particular the region 82SB is also connected to the wall element 82 facing the vehicle by a bend 82U, with the result that this bend provides additional stabilization of the wall region 82 facing the vehicle, in particular in the central region 61.

As a result of the beads 82si and 88si, in particular the wall element 82 facing the vehicle and the wall element 88 facing away from the vehicle are stabilized in the region of the cutout 92 in the lower wall element 86, since in this region the lower wall element 86 has only reduced stiffness.

Reference is made to the statements regarding the first exemplary embodiment in respect of features that are not explicitly described.

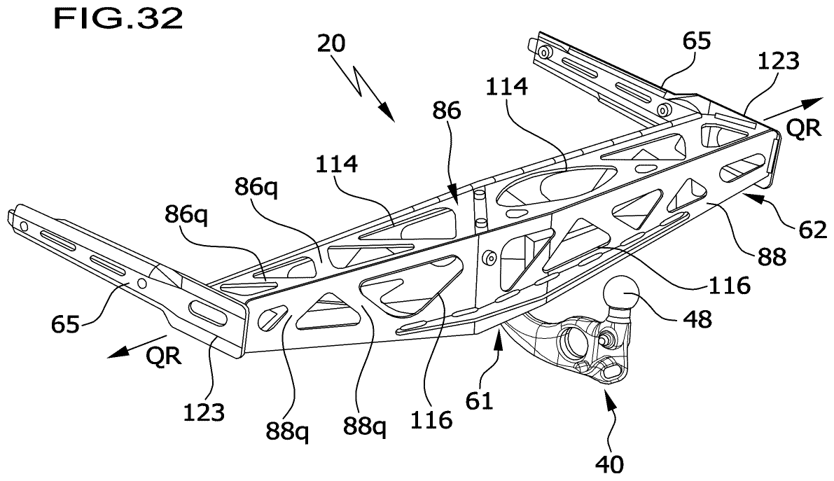

In a seventh exemplary embodiment of a vehicle attachment unit 20 according to the invention, illustrated in FIG. 32, the impact body 62 is connected to the vehicle rear 14 by mounting bodies taking the form of carrying bodies 65, which are mountable on side walls of the vehicle rear 14.

The carrying bodies 65 likewise have deformable connection elements 123 that are fixedly connected to the impact body 62 at the end.

In this seventh exemplary embodiment, illustrated in FIG. 32, the impact body takes the same form in cross section as that described in the third exemplary embodiment of the vehicle attachment unit 20.

In addition, the impact body in this exemplary embodiment also has cutouts 114 and 116, but in this exemplary embodiment these have a triangular shape and are arranged such that transverse webs 88q of the wall element facing away from the vehicle and transverse webs 86q of the upper wall element 86 remain between the cutouts 116 and 114 respectively, wherein successive transverse webs 88q and 86q run transversely to one another and so the transverse webs 88q and 86q form a structure in the manner of a framework, which in this case results in a high resistance to deflection and torsion of the impact body 62.

Reference is made to the statements regarding the third exemplary embodiment in respect of features that are not explicitly described.

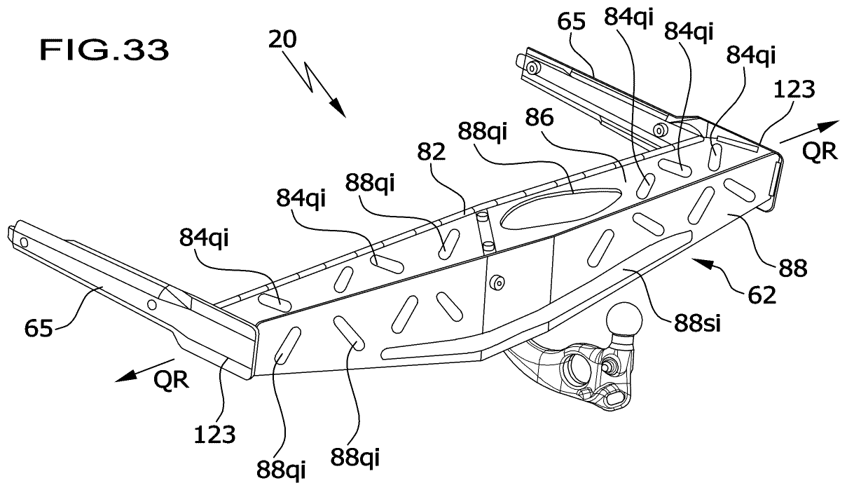

In an eighth exemplary embodiment of a vehicle attachment unit 20, which is based on the underlying concept of the sixth exemplary embodiment according to FIGS. 29 to 31, for example the thickness of the sheet metal of the wall elements 82, 84, 86, 88 is further reduced and is for example less than 3 mm, wherein the material is a high-strength material that has for example a tensile strength of 800 MPa or more. (FIG. 33)

With a sheet-metal material of this kind, in particular no cutouts for the purpose of saving on weight are absolutely necessary, but for the purpose of stiffening it beads are provided, as for example the bead 88si in the wall element 88 facing away from the vehicle, which was also already provided in the case of the exemplary embodiment according to FIG. 30, and preferably also additional beads 88qi, which run obliquely to the transverse direction QR of the impact body 62 such that successive beads 88qi in the transverse direction QR themselves run transversely to one another, with the result that beads 88qi additionally contribute to resistance to twisting.

Similarly, beads 84qi running transversely to the transverse direction QR are also provided in the upper wall element 84 and are likewise arranged such that beads running subsequent to one another in the transverse direction QR likewise run transversely to one another.

However, beads of this kind may also be provided in the wall element 82 facing the vehicle and the lower wall element 86.

The advantage of this solution can be seen in the fact that, because of the thin wall thickness and high tensile strength of the sheet-metal material, it does not make sense to make cutouts, but the beads 88si, 88qi and 84qi make improved stiffness achievable at the same time as stability comparable to the exemplary embodiments above.

In all the exemplary embodiments according to the invention, it is preferably provided for the weld seams to be laser weld seams, which impair the strength of the material itself as little as possible.

Even more advantageous, in particular in the case of the connections in which no projections of the one wall element penetrate into recesses in the other wall element, but rather metal sheets—in particular thin metal sheets—are connected by fillet welds, is preferably a cold-weld process or CMT (cold metal transfer) welding process, which has even less effect on the strength of the material used but ensures a high stability because of the additional material.

1. A vehicle attachment unit which is mountable or mounted on a vehicle rear and on which a trailer element, in particular a ball neck, is mountable when necessary, wherein the vehicle attachment unit comprises a crumple unit, which is mountable on the vehicle rear below a bumper unit and has an impact body that extends transversely to a longitudinal center plane which, in the condition mounted on the vehicle rear, coincides with a vehicle longitudinal center plane, and mounting bodies arranged to either side of the longitudinal center plane, supporting the impact body in relation to the vehicle rear and maintaining a spacing therefrom, and wherein the crumple unit is configured for the motor vehicle and meets crash requirements thereof on the motor vehicle with no trailer element provided.

2. The vehicle attachment unit as claimed in claim 1, wherein the crumple unit of the vehicle attachment unit is adapted for introducing into the vehicle rear the forces that occur when a trailer element is mounted.

3. The vehicle attachment unit as claimed in claim 1, wherein the impact body of the crumple unit is connectable to the trailer element, and wherein when the trailer element is connected to the crumple unit the crumple unit transmits to the vehicle rear all the forces which act on the trailer element during use of the trailer coupling.

4. The vehicle attachment unit as claimed in claim 1, wherein the impact body takes the form of a hollow body.

5. The vehicle attachment unit as claimed in claim 4, wherein the impact body has a cross section with at least three corners.

6. The vehicle attachment unit as claimed in claim 1, wherein the impact body has a wall element facing the vehicle and a wall element facing away from the vehicle, and wherein an upper wall element facing away from a road and a lower wall element facing a road extend between these, and wherein the wall elements are fixedly connected to one another.

7. The vehicle attachment unit as claimed in claim 6, wherein at least some of the wall elements are connected to one another by a weld connection.

8. The vehicle attachment unit as claimed in claim 1, wherein the impact body is provided with stiffening in a central region.

9. The vehicle attachment unit as claimed in claim 1, wherein the impact body is provided with cutouts to the side of the central region.

10. The vehicle attachment unit as claimed in claim 1, wherein the cutouts have an extent in a transverse direction of the impact body that is at most 1.5 times their extent transversely to the transverse direction.

11. The vehicle attachment unit as claimed in claim 10, wherein wall regions of the impact body that have an extent in the transverse direction of at least 0.5 times the extent of the cutouts are located between the cutouts in the transverse direction.

12. The vehicle attachment unit as claimed in claim 9, wherein the wall regions located between the cutouts in the transverse direction run, at least in certain regions, transversely to the transverse direction.

13. The vehicle attachment unit as claimed in claim 9, wherein the cutouts have at least one of i) an external contour of substantially round basic shape and ii) an external contour of substantially oval basic shape.

14. The vehicle attachment unit as claimed in claim 9, wherein the cutouts have an external contour having the basic shape of a triangle, in particular with rounded corner regions.

15. The vehicle attachment unit as claimed claim 9, wherein the cutouts, in relation to the wall regions surrounding them, have edge regions that are raised up relative to the wall regions.

16. The vehicle attachment unit as claimed in claim 15, wherein the raised-up edge regions have a height transversely to the wall regions surrounding them that corresponds to at least twice a thickness of the surrounding wall regions.

17. The vehicle attachment unit as claimed in claim 4, wherein at least some of the wall elements have enhanced resistance to deformations as a result of shaping.

18. The vehicle attachment unit as claimed in claim 17, wherein at least two wall elements are formed in one piece as a result of shaping.

19. The vehicle attachment unit as claimed in claim 1, wherein at least one of the wall elements and the wall element extending away from this are parts of an angled or profiled body, for example a U-shaped profile.

20. The vehicle attachment unit as claimed in claim 17, wherein at least one of the wall elements has a stamped bead.

21. The vehicle attachment unit as claimed in claim 17, wherein at least one of the wall elements has stamped beads which are arranged successively in the transverse direction of the impact body.

22. The vehicle attachment unit as claimed in claim 21, wherein the successively arranged beads run obliquely to the transverse direction.

23. The vehicle attachment unit as claimed in claim 22, wherein successive beads in the transverse direction each run transversely to one another.

24. The vehicle attachment unit as claimed in claim 4, wherein, in the region of a connection between two of the wall elements, at least one of the wall elements projects beyond the other wall element by a web region.

25. The vehicle attachment unit as claimed in claim 24, wherein the web region also has a bend.

26. The vehicle attachment unit as claimed in claim 4, wherein a laser weld seam is provided for the purpose of connecting two mutually abutting wall elements.

27. The vehicle attachment unit as claimed in claim 4, wherein, where two mutually adjoining wall elements are connected, they form a push-in connection.

28. The vehicle attachment unit as claimed in claim 27, wherein, for the purpose of forming the push-in connection, one of the wall elements has a recess in which the other wall element engages by a projection adapted thereto.

29. The vehicle attachment unit as claimed in claim 27, wherein the wall elements are welded to one another at least in the region of the push-in connection.

30. The vehicle attachment unit as claimed in claim 4, wherein the course taken by at least one of the wall elements differs from a course in one plane.

31. The vehicle attachment unit as claimed in claim 4, wherein the wall element facing away from the vehicle is curved in the direction away from the wall element facing the vehicle.

32. The vehicle attachment unit as claimed in claim 1, wherein a mounting base for mounting the trailer element is mountable on the impact body of the crumple unit.

33. The vehicle attachment unit as claimed in claim 1, wherein the mounting base is mountable such that it is integrated into the impact body.

34. The vehicle attachment unit as claimed in claim 1, wherein the mounting base is connected, preferably detachably connectable, to the wall element facing the vehicle and the wall element facing away from the vehicle and in particular also to the upper wall element.

35. The vehicle attachment unit as claimed in claim 1, wherein the lower wall element facing a road has a cutout for installation of the mounting base.

36. The vehicle attachment unit as claimed in claim 35, wherein the cutout is dimensioned such that it is possible to mount the mounting base with the trailer element previously mounted thereon.

37. The vehicle attachment unit as claimed in claim 1, wherein there is held on the mounting base a bearing unit, in particular a pivotal bearing unit, for the trailer element, by which the trailer element is pivotal from a working position into a rest position.

38. The vehicle attachment unit as claimed in claim 37, wherein, in the rest position, the trailer element is at least partly, in particular entirely, received in the impact body.

39. The vehicle attachment unit as claimed in claim 1, wherein the lower wall element is provided, in the central region receiving the mounting base, with a cutout of which the extent is such that the mounting unit, together with the bearing unit mounted thereon, is insertable between the wall element facing the vehicle and the wall element facing away from the vehicle, and is mountable such that it is integrated into the impact body, with the result that in particular the entire mounting base, together with the bearing unit, is located within the impact body.

40. The vehicle attachment unit as claimed in claim 39, wherein the mounting base runs obliquely to both the wall element facing away from the vehicle and also the wall element facing the vehicle and abuts against them by way of mounting flanges.

41. The vehicle attachment unit as claimed in claim 40, wherein the mounting unit has another mounting flange that is configured to abut against the upper wall element and to be connected thereto.

42. The vehicle attachment unit as claimed in claim 1, wherein the mounting base, with the bearing unit mounted thereon and together with the trailer element held by the bearing unit, is insertable as a whole into the impact body by way of a cutout in the lower wall element.

43. The vehicle attachment unit as claimed in claim 42, wherein the mounting base is connectable to the wall element facing the vehicle by way of a mounting flange and to the wall element facing away from the vehicle by way of a mounting flange and to the upper wall element by way of a mounting flange.

44. The vehicle attachment unit as claimed in claim 1, wherein the mounting base is detachably connectable to the wall elements by way of the mounting flanges.

45. The vehicle attachment unit as claimed in claim 1, wherein the mounting base is connectable to the wall elements by way of the mounting flanges using screws.

46. The vehicle attachment unit as claimed in claim 1, wherein the mounting base is formed from molded parts made of flat material that are connected to one another and are for example mutually overlapping or arranged at a spacing from one another.

47. The vehicle attachment unit as claimed in claim 1, wherein the mounting base is configured as a solid component that is connectable by way of edge regions respectively to the wall element facing the vehicle, the wall element facing away from the vehicle and the upper wall element.

48. The vehicle attachment unit as claimed in claim 1, wherein the respective mounting body takes the form of a deformation body and is supported on a foot that abuts or is configured to abut against the vehicle rear.

49. The vehicle attachment unit as claimed in claim 48, wherein each of the feet has a central region that takes a planar form.

50. The vehicle attachment unit as claimed in claim 48, wherein the feet are fixable to the vehicle rear by way of anchoring elements.

51. The vehicle attachment unit as claimed in claim 50, wherein the feet are provided with anchoring elements engaging with a stabilized region of the vehicle rear.

52. The vehicle attachment unit as claimed in claim 1, wherein the deformation bodies have connection elements arranged between the respective foot and a holding region of the impact body.

53. The vehicle attachment unit as claimed in claim 52, wherein the connection elements have fingers that are fixedly connected to the holding region of the impact body.

54. The vehicle attachment unit as claimed in claim 53, wherein the fingers abut against the lower and upper wall elements of the impact body and are connected to holding regions thereof.

55. The vehicle attachment unit as claimed in claim 53, wherein the connection elements have a supporting web that extends between the fingers, and wherein provided in particular in the respective connection element between the supporting web and the foot is a central opening.

56. The vehicle attachment unit as claimed in claim 55, wherein the wall element of the impact body that faces the vehicle abuts against the supporting web and is in particular fixedly connected thereto.

57. The vehicle attachment unit as claimed in claim 53, wherein the wall element facing away from the vehicle abuts on the fingers.

58. The vehicle attachment unit as claimed in claim 53, wherein the holding regions, which are connected to the fingers, of the upper and lower wall elements are decoupled from the wall element facing the vehicle by cutouts.

59. The vehicle attachment unit as claimed in claim 57, wherein the connection elements take a form such that in the event of a crash they deform as a whole in the direction of the crash.

60. The vehicle attachment unit as claimed in claim 52, wherein additional energy absorption elements, which in the event of a crash deform in the direction of the crash, are associated with the connection elements of the deformation bodies.

61. The vehicle attachment unit as claimed in claim 60, wherein the additional energy absorption elements are configured to take up forces that are transmitted from the trailer element to the impact body.

62. The vehicle attachment unit as claimed in claim 60, wherein the additional energy absorption elements take the form of bodies that fold up in the direction of a crash.

63. The vehicle attachment unit as claimed in claim 60, wherein the additional energy absorption elements have a central body and, extending from this, support elements that run on one side to the foot and on the other to the impact body and in the event of a crash are foldable in the direction of the crash.

64. The vehicle attachment unit as claimed in claim 60, wherein the additional energy absorption elements take the form of hollow bodies.

65. The vehicle attachment unit as claimed in claim 64, wherein the hollow bodies extend around a geometric axis, and wherein the geometric axis runs in the direction of a crash or transversely to the direction of a crash.
